(19) United States
(12) Patent Application Publication
(10) Pub. No.: US 2026/0178433 A1
(43) Pub. Date: Jun. 25, 2026

(54) LABEL CREATION DEVICE, DIAGNOSTIC MODEL CREATION DEVICE, DEGRADATION DIAGNOSTIC DEVICE, INFORMATION PROCESSING SYSTEM, AND LABEL CREATION METHOD

(71) Applicant: Mitsubishi Electric Corporation, Tokyo (JP)

(72) Inventors: Miyu UEMURA, Tokyo (JP); Yuki TANAKA, Tokyo (JP)

(73) Assignee: Mitsubishi Electric Corporation, Tokyo (JP)

(21) Appl. No.: 19/432,417

(22) Filed: Dec. 24, 2025

Related U.S. Application Data
(63) Continuation of application No. PCT/JP2023/026914, filed on Jul. 24, 2023.

(51) Int. Cl. G06F 11/07; G06F 11/00

(52) U.S. Cl. CPC G06F 11/079; G06F 11/008

(57) ABSTRACT

A label creation device includes processing circuitry configured to: acquire training data in which a feature to be used to create a diagnostic model used in degradation diagnosis on a target apparatus as a degradation diagnosis subject is associated with external factor data related to an operating environment; classify a range of value of the external factor data into a constant band that is a range of value of the external factor data in which a relationship with the corresponding feature is estimated to be constant, and a transition band that is a range of value of the external factor data in which the relationship changes frequently; and assign an external factor label indicating that a relationship is constant, assign an external factor label indicating that the relationship changes frequently, with respect to the axis of the external factor data, and create external factor label data.

### CROSS REFERENCE TO RELATED APPLICATION

This application is a Continuation of PCT International Application No. PCT/JP2023/026914, filed on Jul. 24, 2023, which is hereby expressly incorporated by reference into the present application.

### TECHNICAL FIELD

The present disclosure relates to a label creation device, a diagnostic model creation device, a degradation diagnostic device, an information processing system, and a label creation method that assist in construction of a diagnostic model to be used in degradation diagnosis on an apparatus.

### BACKGROUND ART

There has been a known technique for performing degradation diagnosis on an apparatus, using a model (hereinafter referred to as the “diagnostic model”) that has been created on the basis of a feature extracted from data acquired from the apparatus.

Meanwhile, as a technique for performing a diagnosis on an operating state of an apparatus using a diagnostic model, Patent Literature 1 discloses a diagnostic system that manages apparatuses having similar operating conditions as a group under a common apparatus feature pattern number, and performs a diagnosis on an apparatus state reflecting the feature of the apparatus, using a diagnosis pattern suitable for the apparatus feature pattern number.

### CITATION LIST

### Patent Literature

Patent Literature 1: JP 2016-91378 A

### SUMMARY OF INVENTION

### Technical Problem

A feature that is used in degradation diagnosis on an apparatus changes with the operating environment, in addition to the degraded state of the apparatus. Therefore, the diagnostic model to be used in the degradation diagnosis on the apparatus needs to be constructed as a model capable of diagnosing a normal state or a degraded state while taking into consideration the influence of the operating environment.

However, the index of the operating environment is likely to have continuous values, and there is a possibility that a highly accurate diagnosis result cannot be obtained even if any of the diagnostic models before and after switching is used at the boundary of the switching between diagnostic models depending on the operating environment.

The conventional technique has a problem that it is difficult to construct a diagnostic model with this point taken into consideration. As a result, there is a possibility that the accuracy of the result of the degradation diagnosis performed on the apparatus with the diagnostic model on the basis of the feature has decreased.

Note that, regarding the operating condition of the apparatus, the possibility that the index have continuous values is low. That is, there is a low possibility that the accuracy of the diagnosis result will decrease at the boundary of switching of diagnostic models depending on the operating condition of the apparatus. By a technique for performing a diagnosis on an apparatus state with the diagnostic pattern corresponding to the apparatus feature pattern in the diagnostic system as disclosed in Patent Literature 1, the influence of the operating environment on the diagnosis result is not taken into consideration, and the problem as described above has not been solved yet.

The present disclosure has been made to solve problems as described above, and aims to provide a label creation device capable of providing data that assists in construction of a diagnostic model that prevents a decrease in accuracy of degradation diagnosis on an apparatus due to an operating environment.

### Solution to Problem

A label creation device according to the present disclosure includes: processing circuitry configured to: acquire training data in which a feature to be used to create a diagnostic model used in degradation diagnosis on a target apparatus as a degradation diagnosis subject is associated with external factor data related to an operating environment; classify, on a basis of the acquired training data, a range of value of the external factor data in an axial direction of the external factor data into a constant band that is a range of value of the external factor data in which a relationship with the corresponding feature is estimated to be constant, and a transition band that is a range of value of the external factor data in which the relationship with the corresponding feature is estimated to change frequently; and assign an external factor label indicating that a relationship between the external factor data in the range and the corresponding feature is constant, to the range of value of the external factor data classified as the constant band, with respect to an axis of the external factor data, assign an external factor label indicating that the relationship between the external factor data in the range and the corresponding feature changes frequently, to the range of value of the external factor data classified as the transition band, with respect to the axis of the external factor data, and create external factor label data in which ranges of value of the external factor data are associated with external factor labels.

### Advantageous Effects of Invention

According to the present disclosure, with a configuration as described above, it is possible to provide data that assists in construction of a diagnostic model that prevents a decrease in accuracy of degradation diagnosis on an apparatus due to an operating environment. As a result, it is possible to construct a diagnostic model that prevents a decrease in accuracy of a result of the degradation diagnosis performed on the apparatus with the diagnostic model on the basis of the feature, and it is possible to achieve degradation diagnosis with high accuracy using the diagnostic model.

### BRIEF DESCRIPTION OF DRAWINGS

FIG. 1 is a diagram illustrating an example configuration of an information processing system including a label creation device according to a first embodiment.

FIG. 2 is a diagram illustrating an example configuration of a diagnostic model creation device according to the first embodiment including the label creation device according to the first embodiment.

FIG. 3 is a diagram for explaining a method to be implemented by an external factor region dividing unit to divide the range of values of external factor data in the axial direction of the external factor data into a constant band and a transition band in the first embodiment.

FIG. 4 is a diagram for explaining a concept of an example of external factor labels assigned to the axis of external factor data by an external factor label data creating unit in the first embodiment.

FIG. 5 is a diagram for explaining a concept of an example of the contents of external factor label data created by the external factor label data creating unit in the first embodiment.

FIG. 6 is a diagram illustrating an example configuration of a degradation diagnostic device according to the first embodiment.

FIG. 7 is a diagram for explaining an example of a method by which a diagnosis unit determines a diagnostic model corresponding to a feature extracted by a feature extracting unit among the diagnostic models output from a model acquiring unit in the first embodiment.

FIG. 8 is a flowchart for explaining operations to be performed by the diagnostic model creation device according to the first embodiment including the label creation device according to the first embodiment.

FIG. 9 is a flowchart for explaining details of a region dividing process to be performed by the external factor region dividing unit in step ST2 in FIG. 8.

FIG. 10 is a diagram for explaining a problem in a conventional technique.

FIG. 11 is a flowchart for explaining an operation of the degradation diagnostic device according to the first embodiment.

FIG. 12 is a diagram for explaining a concept of an example of external factor labels assigned to the axis of external factor data by the external factor label data creating unit in the label creation device in a case where the label creation device creates external factor data for each of a set of “temperature” and “amplitude value” and a set of “temperature” and “variance” in the first embodiment.

FIGS. 13A and 13B are examples of hardware configuration of the label creation device according to the first embodiment.

### DESCRIPTION OF EMBODIMENTS

To explain the present disclosure in greater detail, modes for carrying out the disclosure are described below with reference to the accompanying drawings.

### First Embodiment

A label creation device according to a first embodiment provides data (hereinafter referred to as “external factor label data”) that assists in construction of a trained model (hereinafter referred to as a “diagnostic model”) to be used in degradation diagnosis on an apparatus (hereinafter referred to as the “target apparatus”) to be subjected to the degradation diagnosis, for example.

The target apparatus is a railway platform door, for example. Note that this is merely an example, and any of various apparatuses whose degradation is related to the surrounding environment or the operating environment in which the target apparatus operates can be a target apparatus. Degradation diagnosis on an apparatus is performed with a diagnostic model, on the basis of a feature extracted from data collected from the apparatus. The feature is affected by the operating environment. Therefore, in a case where the diagnostic model is not created on the assumption that the feature is affected by the operating environment, there is a possibility that the apparatus will be erroneously diagnosed as being degraded due to the change caused in the feature by a change in the operating environment, though not degraded. The label creation device according to the first embodiment prevents such erroneous diagnosis. More specifically, the label creation device according to the first embodiment provides external factor label data that assists in construction of a diagnostic model as a diagnostic model capable of preventing erroneous diagnosis as described above.

In the first embodiment, the operating environment is assumed to be a natural factor that cannot be controlled by humans, such as temperature or precipitation.

In the first embodiment described below, the operating environment that can affect degradation of the target apparatus as described above will be also referred to as an “external factor”.

The external factor label data to be provided by the label creation device is data indicating the relationship between the feature and the external factor that are to be used in degradation diagnosis on the target apparatus.

When the relationship between the feature and the external factor to be used in degradation diagnosis on the target apparatus changes, it is estimated that the diagnostic model for accurately performing the degradation diagnosis on the target apparatus also changes.

Here, as described above, the index of the operating environment is likely to have continuous values, and there is a possibility that a highly accurate diagnosis result cannot be obtained even if any of the diagnostic models before and after the switching is used at the boundary of the switching between diagnostic models depending on the operating environment. In the external factor label data, it is indicated that the relationship between the feature and the external factor is a relationship with a possibility that an accurate diagnosis result cannot be obtained even if any of the diagnostic models is used.

External factor label data can contribute to the construction of an accurate diagnostic model. That is, in degradation diagnosis on the target apparatus using a diagnostic model created on the basis of the external factor label data, acquisition of an accurate diagnosis result can be expected.

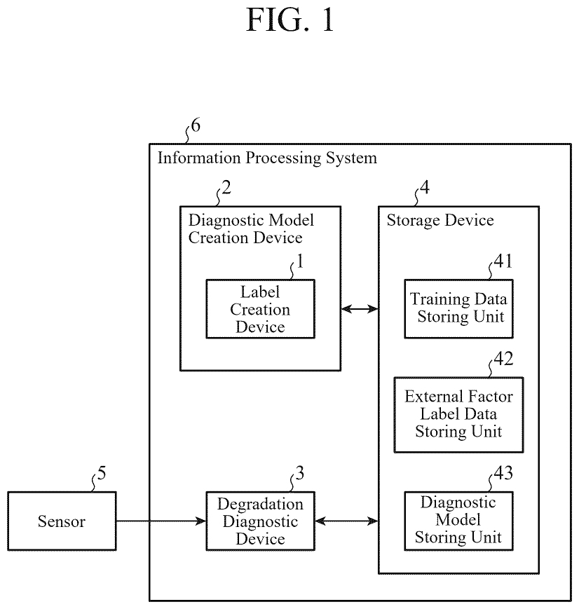

FIG. 1 is a diagram illustrating an example configuration of an information processing system 6 including a label creation device 1 according to the first embodiment.

The information processing system 6 includes the label creation device 1, a diagnostic model creation device 2, a degradation diagnostic device 3, and a storage device 4. Note that, in the first embodiment, the storage device 4 is included in the information processing system 6, but this is merely an example. The information processing system 6 does not necessarily include the storage device 4, and the storage device 4 may be included in a system that is located outside the information processing system 6 and is connected to the information processing system 6, for example.

The label creation device 1, the diagnostic model creation device 2, and the degradation diagnostic device 3 are provided in the target apparatus, for example.

In the first embodiment, the label creation device 1 is included in the diagnostic model creation device 2.

The label creation device 1 creates external factor label data, on the basis of the training data stored in a training data storing unit 41 of the storage device 4. The training data is data in which features are associated with external factor data related to external factors. The training data will be described later in detail.

The label creation device 1 stores the created external factor label data into an external factor label data storing unit 42 of the storage device 4.

The diagnostic model creation device 2 acquires the training data to be used in creating a diagnostic model from the training data storing unit 41 of the storage device 4 on the basis of the external factor label data stored in the external factor label data storing unit 42 by the label creation device 1, and creates a diagnostic model using the acquired training data. The diagnostic model creation device 2 stores the created diagnostic model into a diagnostic model storing unit 43 of the storage device 4.

The label creation device 1 and the diagnostic model creation device 2 will be described later in detail.

The degradation diagnostic device 3 is connected to a sensor 5. The sensor 5 is provided in the target apparatus, for example, collects data related to operating states of the target apparatus (this data will be hereinafter referred to as the “sensor data”) and the external factor data related to the external factors, and outputs the sensor data and the external factor data to the degradation diagnostic device 3. The sensor 5 is a vibration sensor, a temperature sensor, a rainfall sensor, or the like.

The sensor data and the external factor data are time-series data of sensor-measured values over a predetermined time period as obtained by the sensor 5 at predetermined intervals, for example.

The sensor data and the external factor data each indicate a sensor-measured value of vibration, temperature, precipitation, or the like. Note that this is merely an example, and the sensor data may include a control value such as a command value or a reference value over the predetermined time period as obtained by a plurality of sensors 5 at predetermined intervals, for example.

Although only one sensor 5 is shown in FIG. 1 for ease of explanation, a plurality of sensors 5 may exist. The sensor data and the external factor data may be collected from different sensors 5. The degradation diagnostic device 3 may be connected to the plurality of sensors 5.

The degradation diagnostic device 3 acquires diagnostic data including the sensor data and the external factor data from the sensor 5. The degradation diagnostic device 3 determines the diagnostic model to be used in degradation diagnosis on the target apparatus on the basis of the external factor data, and, using the determined diagnostic model, performs the degradation diagnosis on the target apparatus on the basis of the sensor data.

In the first embodiment described below as an example, the degradation diagnostic device 3 acquires, from the sensor 5, vibration data related to vibration of the target apparatus as the sensor data and temperature data as the external factor data.

The degradation diagnostic device 3 outputs a result of the degradation diagnosis to an output device (not shown in the drawing). The output device is a display device or a voice output device included in a personal computer (PC) installed in a management room or the like in which an operator or the like performs a management operation on the target apparatus, for example. The output device may be a display device or a voice output device included in a tablet terminal being carried by an operator, for example.

The degradation diagnostic device 3 will be described later in detail.

The storage device 4 is formed with a hard disk drive (HDD) or a solid state drive (SSD), and includes the training data storing unit 41, the external factor label data storing unit 42, and the diagnostic model storing unit 43, which has been mentioned above.

The training data storing unit 41 stores training data.

The external factor label data storing unit 42 stores the external factor label data created by the label creation device 1.

The diagnostic model storing unit 43 stores the diagnostic model created by the diagnostic model creation device 2.

The storage device 4 may be included in the target apparatus, or may be included in a place that can be referred to by the label creation device 1, the diagnostic model creation device 2, and the degradation diagnostic device 3 outside the target apparatus.

The label creation device 1, the diagnostic model creation device 2, and the degradation diagnostic device 3 according to the first embodiment are now described in detail.

First, the diagnostic model creation device 2 according to the first embodiment including the label creation device 1 according to the first embodiment is described.

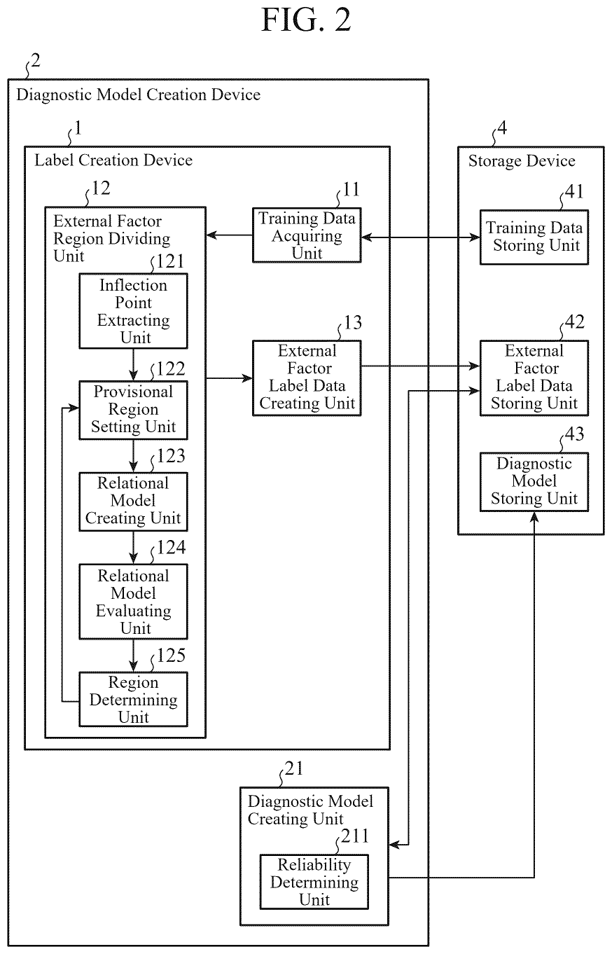

FIG. 2 is a diagram illustrating the diagnostic model creation device 2 according to the first embodiment including the label creation device 1 according to the first embodiment.

The diagnostic model creation device 2 includes the label creation device 1 and a diagnostic model creating unit 21.

The label creation device 1 includes a training data acquiring unit 11, an external factor region dividing unit 12, and an external factor label data creating unit 13.

The external factor region dividing unit 12 includes an inflection point extracting unit 121, a provisional region setting unit 122, a relational model creating unit 123, a relational model evaluating unit 124, and a region determining unit 125.

The training data acquiring unit 11 refers to the training data storing unit 41, and acquires training data.

The training data is created in advance, and is stored in the training data storing unit 41.

In the first embodiment, the training data is data in which features extracted from the sensor data acquired from the sensor 5 at the time of degradation diagnosis performed on the target apparatus by the degradation diagnostic device 3 are associated with operating environments of the target apparatus, which are the external factor data related to external factors.

For example, an administrator or the like acquires beforehand, from the target apparatus, the features extracted from the sensor data collected by the sensor 5 in a past preset period and the external factor data, creates the training data on the basis of the features and the external factor data, and stores the training data into the training data storing unit 41. For example, the administrator or the like is only required to acquire the features extracted on the basis of the sensor data collected from the sensor 5 by the degradation diagnostic device 3 and the external factor data, and create the training data on the basis of the features and the external factor data. The extraction of the features in the degradation diagnostic device 3 will be described later. Alternatively, the degradation diagnostic device 3 may have a function of creating training data on the basis of the extracted features, for example, and store the training data into the training data storing unit 41. Note that, in the first embodiment, the sensor data may be the features, which are the training data.

The training data is only required to include the features based on the sensor data created in a case where the target apparatus is in a normal state, or the features based on the sensor data created on the assumption that the target apparatus is in a normal state. The training data does not necessarily include the features based on the sensor data created in a case where the target apparatus is in an abnormal state, or the features based on the sensor data created on the assumption that the target apparatus is in an abnormal state.

Note that the features included in the training data are determined beforehand by the administrator or the like. The administrator or the like sets, as the features included in the training data, features related to degraded states of the apparatus, or, in other words, features that can be an input of a diagnostic model.

The training data acquiring unit 11 outputs the acquired training data to the external factor region dividing unit 12.

On the basis of the training data output from the training data acquiring unit 11, the external factor region dividing unit 12 divides the range of values of external factor data in the axial direction of the external factor data into a range of values of external factor data whose relationship with the corresponding features is estimated to be constant (this range will be hereinafter referred to as the “constant band”) and a range of values of external factor data whose relationship with the corresponding features is estimated to change frequently (this range will be hereinafter referred to as the “transition band”).

As described above, in a case where the relationship between the features and the external factors changes in the training data, it is estimated that diagnostic model also changes. That is, when the relationship between the features and the external factor data changes frequently in the training data, the diagnostic model to be created on the basis of the training data may also change frequently. In this case, there is a possibility that an accurate diagnostic result will not be obtained even if any frequently changing diagnostic model is used. On the other hand, when the relationship between the features and the external factor is constant in the training data, the diagnostic model does not change frequently. That is, it is estimated that the same diagnostic model can be used in degradation diagnosis. This is based on the concept that, as for an external factor affecting a feature, the influence of the external factor on the feature can be corrected by the same technique or with the same parameter unless the relationship between the feature and the external factor changes, and thus, it is estimated that the same diagnostic model can be adopted.

In the first embodiment, the process to be performed by the external factor region dividing unit 12 to divide the range of values of the external factor data in the axial direction of the external factor data into the constant band and the transition band is referred to as the “region dividing process”.

Here, the dividing into the constant band and the transition band by the external factor region dividing unit 12 is described in detail, with reference to the drawings.

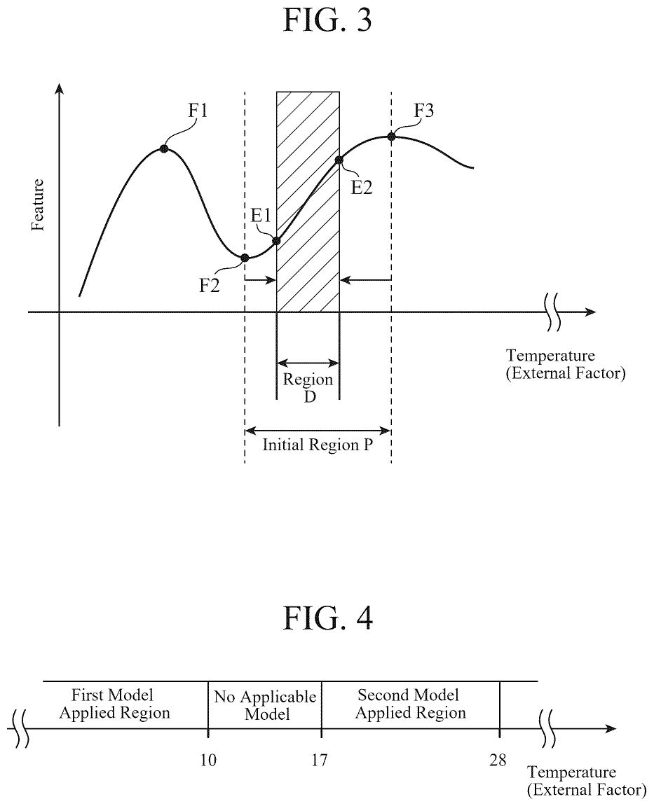

FIG. 3 is a diagram for explaining a method to be implemented by the external factor region dividing unit 12 to divide the range of values of the external factor data in the axial direction of the external factor data into the constant band and the transition band in the first embodiment.

FIG. 3 illustrates the relationship between a feature (amplitude value herein) based on the training data and an external factor (temperature herein), the vertical axis indicating values of the feature, the horizontal axis indicating values of the external factor.

As described above, the external factor region dividing unit 12 includes the inflection point extracting unit 121, the provisional region setting unit 122, the relational model creating unit 123, the relational model evaluating unit 124, and the region determining unit 125.

First, the inflection point extracting unit 121 extracts a plurality of inflection points in the axial direction of the external factor data associated with the feature in the training data, on the basis of the training data output from the training data acquiring unit 11.

In the first embodiment, an inflection point refers to a point at which the relationship between the external factor data and the feature changes in the axial direction of the external factor data.

In FIG. 3, the inflection points extracted by the inflection point extracting unit 121 are denoted by “F1”, “F2”, and “F3”.

As illustrated in FIG. 3, the inflection point extracting unit 121 extracts inflection points that are the points (“F1” and “F3”) at which the value of the feature changes from rising to falling, and the point (“F2”) at which the value changes from falling to rising in the axial direction of the external factor data, for example.

The inflection point extracting unit 121 adds data indicating the inflection points to the training data output from the training data acquiring unit 11, and outputs the training data having the data indicating the inflection points added thereto (this training data will be hereinafter referred to as the “inflection-point-added training data”), to the provisional region setting unit 122.

Next, the provisional region setting unit 122 selects adjacent inflection points (referred to as a first inflection point and a second inflection point) among the inflection points extracted by the inflection point extracting unit 121, on the basis of the inflection-point-added training data output from the inflection point extracting unit 121. For example, the provisional region setting unit 122 sets “F2” as the first inflection point, and “F3” as the second inflection point.

The provisional region setting unit 122 sets the range of values of the external factor data between the selected first inflection point and second inflection point as an inflection point range, and sets a provisional region to be a candidate for the constant band within the inflection point range.

The provisional region setting unit 122 sets the initial region of the provisional region, which is the range (the inflection point range) from the value of the external factor data at the first inflection point to the value of the external factor data at the second inflection point. In FIG. 3, the initial region of the provisional region is denoted by “P”.

The provisional region setting unit 122 outputs the value of the external factor data in the set provisional region and the value of the feature corresponding to the value of the external factor data, to the relational model creating unit 123. Where the initial region “P” is the provisional region, the provisional region setting unit 122 outputs the value of the external factor data and the value of the feature from those at the first inflection point “F2” to those at the second inflection point “F3”, to the relational model creating unit 123.

Next, the relational model creating unit 123 creates a model indicating the relationship between the feature and the external factor data (this model will be hereinafter referred to as the “relational model”), on the basis of the values of the external factor data in the provisional region and the values of the feature corresponding to the values of the external factor data. The relational model is represented by a linear expression, for example.

If the provisional region is the initial region “P”, for example, the relational model creating unit 123 creates the relational model, on the basis of the value of the external factor data and the value of the feature from those at the first inflection point “F2” to those at the second inflection point “F3”.

The relational model creating unit 123 outputs the created relational model to the relational model evaluating unit 124, together with the value of the external factor data in the provisional region and the value of the feature corresponding to the value of the external factor data output from the provisional region setting unit 122, which are the training data in the provisional region.

Next, the relational model evaluating unit 124 evaluates the accuracy of the relational model, using the value of the external factor data included in the provisional region and the value of the feature corresponding to the value of the external factor data.

For example, it is assumed that the relational model is represented by the following linear expression (1). Note that, in the following linear expression (1), y represents the feature, and x represents the external factor data.

y=x+3 (1)

The relational model evaluating unit 124 substitutes the value of certain external factor data in the provisional region (here, the range between the first inflection point “F2” and the second inflection point “F3”, for example) and the value of the feature corresponding to the value of the external factor data into the relational model created by the relational model creating unit 123.

The relational model evaluating unit 124 then determines the error between the value of the feature obtained by performing the above substitution into the relational model and the value of the substituted feature.

For example, if external factor data “21° C.” and a feature “25 mm” are substituted into the relational model, the obtained feature is “24 mm”, and the error is “1 mm”.

The relational model evaluating unit 124 evaluates the relational model by comparing the calculated error with a preset threshold (hereinafter referred to as the “relational model evaluating threshold”), for example. For example, the relational model evaluating unit 124 determines the accuracy of the relational model to be sufficiently high when the error is equal to or smaller than the relational model evaluating threshold, and determines the accuracy of the relational model to be low when the error is greater than the relational model evaluating threshold.

The relational model evaluating unit 124 outputs the result of the evaluation of the relational model to the region determining unit 125, together with the value of the external factor data in the provisional region and the value of the feature corresponding to the value of the external factor data.

The region determining unit 125 then determines whether the relational model is evaluated to have a sufficiently high accuracy, on the basis of the result of the relational model evaluation output from the relational model evaluating unit 124.

In a case where it is determined that the accuracy of the relational model is evaluated to be sufficiently high, the region determining unit 125 determines to classify the provisional region in which the accuracy of the relational model is evaluated to be high as a constant band. The region determining unit 125 then determines to classify a range of values of the external factor data other than the determined constant band as a transition band in the inflection point range.

In a case where it is determined that the accuracy of the relational model is not evaluated to be sufficiently high, or the accuracy of the relational model is evaluated to be low, on the other hand, the region determining unit 125 outputs an instruction to the provisional region setting unit 122 to narrow the range of the provisional region and re-set the provisional region. The provisional region setting unit 122 re-sets the provisional region, on the basis of the instruction from the region determining unit 125. Specifically, the provisional region setting unit 122 narrows the range of values of the external factor data at both ends of the provisional region, and re-sets the provisional region.

Assuming that the accuracy of the relational model is evaluated to be sufficiently high, the region determining unit 125 determines to classify the provisional region, which is the range between the first inflection point “F2” and the second inflection point “F3”, as a constant band. Since there are no regions other than the constant band in the provisional region, or there is no range of values of the external factor data in this case, the region determining unit 125 does not set any transition band in the provisional region, which is the range between the first inflection point “F2” and the second inflection point “F3”.

If it is determined that the accuracy of the relational model is currently evaluated to be low, the region determining unit 125 outputs an instruction to the provisional region setting unit 122 to narrow the range of the provisional region and re-set the provisional region. In this case, the provisional region setting unit 122 re-sets the range of the external factor data denoted by “D” in FIG. 3 (the range of values of the external factor data from that at the point denoted by “E1” to that at the point denoted by “E2” in FIG. 3) as the provisional region, for example. Note that how much the range of the external factor data to be re-set as the provisional region from both ends of the provisional region before re-setting is narrowed in a case where an instruction to re-set the provisional region is output is determined in advance.

The provisional region setting unit 122 outputs the value of the external factor data in the re-set provisional region and the value of the feature corresponding to the value of the external factor data, to the relational model creating unit 123.

The relational model creating unit 123 re-creates the relational model, and outputs the re-created relational model to the relational model evaluating unit 124. The relational model evaluating unit 124 re-evaluates the recreated relational model, and outputs the result of evaluation of the re-evaluated relational model to the region determining unit 125.

The provisional region setting unit 122, the relational model creating unit 123, and the relational model evaluating unit 124 each reset the provisional region, re-create the relational model, and re-evaluate the accuracy of the relational model, until the region determining unit 125 determines to classify the provisional region as a constant band, or until the region determining unit 125 determines that the provisional region cannot be classified as a constant band.

In a case where the provisional region set by the provisional region setting unit 122 is smaller than a preset range (hereinafter referred to as the “minimum provisional region range”), the region determining unit 125 determines that the provisional region cannot be set as a constant band even if the relational model is evaluated to have a sufficiently high accuracy, and sets the provisional region as a transition band. The region determining unit 125 then determines to classify a range of values of the external factor data other than the provisional region as a transition band in the inflection point range.

It can be said that, in a case where the accuracy of the relational model is sufficiently high, a certain relationship between the feature and the external factor is established in the range of values of the external factor data for which the relational model has been created. In other words, the influence of the external factor on the feature can be easily estimated. It is assumed that the diagnostic model created from the feature corresponding to the external factor in this range can be a diagnostic model having a low possibility that the accuracy of degradation diagnosis is lowered due to the external factor in a case where the degradation diagnosis is performed on the target apparatus with the diagnostic model. That is, it is estimated that the same diagnostic model can be used in degradation diagnosis for the feature corresponding to the external factor in this range.

On the other hand, it can be said that, in a case where the accuracy of the relational model is low, any certain relationship between the feature and the external factor is not established in the range of values of the external factor data for which the relational model has been created. That is, it is estimated that the relationship between the feature and the external factor changes frequently. In other words, it is assumed that it is difficult to estimate the influence of the external factor on the feature. It is assumed that the diagnostic model created from training data including the feature corresponding to the external factor in this range is a diagnostic model having a possibility of lowering the accuracy of degradation diagnosis due to the external factor in a case where the degradation diagnosis is performed on the target apparatus with the diagnostic model. This is because, if the relationship between the feature and the external factor affecting the feature changes frequently, the influence of the external factor on the feature cannot be corrected by the same technique or with the same parameter, and the diagnostic model for performing degradation diagnosis with high accuracy is estimated to change frequently.

Note that, even in a case where the accuracy of the relational model is sufficiently high, if the range of the external factor data for which the relational model has been created is smaller than the minimum provisional region range, it can be said that there is no enough data for evaluating the relationship between the feature and the external factor. It is doubtful whether it can be said that the diagnostic model created from the training data including the feature corresponding to the external factor in this range has a low possibility of lowering the accuracy of degradation diagnosis due to the external factor in a case where the degradation diagnosis is performed on the target apparatus with the diagnostic model. Therefore, in this case, the region determining unit 125 determines that it is assumed that there is no range that can be classified as a constant band in the inflection point range, or that the diagnostic model created from training data including the feature corresponding to the external factor in this inflection point range is a diagnostic model having a possibility of lowering the accuracy of degradation diagnosis due to the external factor in a case where the degradation diagnosis is performed on the target apparatus with the diagnostic model, as described above.

By performing the extraction of inflection points, the setting of the provisional region, the creation of the relational model, the evaluation of the relational model, and the classification of the constant band and the transition band as described above between all the inflection points, the external factor region dividing unit 12 classifies the constant band and the transition band in the range of values of all the external factor data in the axial direction of the external factor data.

The external factor region dividing unit 12 outputs, to the external factor label data creating unit 13, data (which will be hereinafter referred to as the “region setting data”) regarding the constant band or the transition band classified in the range of values of the external factor data in the axial direction of the external factor data.

The region setting data is data in which data indicating the range of values of the external factor data and data indicating whether the range is the constant band or the transition band are associated with each other.

On the basis of the region setting data output from the external factor region dividing unit 12, the external factor label data creating unit 13 assigns, with respect to the axis of the external factor data, an external factor label indicating the range in which the relationship with the feature corresponding to the external factor data in the range is constant, or indicating that the range is the constant band, to the range of values of the external factor data classified as the constant band, and assigns an external factor label indicating the range in which the relationship with the corresponding feature is estimated to change frequently, or indicating that the range is the transition band, to the range of values of the external factor data classified as the transition band.

Here, FIG. 4 is a diagram for explaining a concept of an example of external factor labels assigned to the axis of external factor data by the external factor label data creating unit 13 in the first embodiment.

In FIG. 4, regarding an external factor (temperature herein), the range less than 10° C. is classified as a constant band, the range from 10° C. or more to less than 17° C. is classified as a transition band, and the range from 17° C. or more to less than 28° C. is classified as a constant band by the external factor region dividing unit 12.

In this case, with respect to the axis of the external factor data, the external factor label data creating unit 13 assigns an external factor label indicating that the range less than 10° C. is a constant band (in which the relationship between the feature and the external factor data is constant) and is a range in which it is estimated that the same diagnostic model (hereinafter referred to as the “first diagnostic model”) can be used. In FIG. 4, the external factor label is shown as “first model applied region”.

Also, the external factor label data creating unit 13 assigns an external factor label indicating that the range from 10° C. or more to less than 17° C. in the axial direction of the external factor data is a transition band, or is a range in which the relationship between the corresponding feature and the external factor data is estimated to change frequently. In FIG. 4, the external factor label is shown as “no applicable model”.

In this case, with respect to the axis of the external factor data, the external factor label data creating unit 13 assigns an external factor label indicating that the range from 17° C. or more to less than 28° C. is a constant band (in which the relationship between the feature and the external factor data is constant) and is a range in which it is estimated that the same diagnostic model (hereinafter referred to as the “second diagnostic model”) different from the first diagnostic model can be used. In FIG. 4, the external factor label is shown as “second model applied region”.

As illustrated in FIG. 4, in a case where there is a plurality of constant bands, the external factor label data creating unit 13 assigns external factor labels to the respective constant bands so that it is clear that training data assumed to have been acquired in the operating environment indicated by the external factor data in the range is estimated to be able to use different diagnostic models.

After assigning the external factor labels, the external factor label data creating unit 13 creates data related to the external factor labels (this data will be hereinafter referred to as the “external factor label data”).

The external factor label data is data in which the ranges of values of the external factor data are associated with the external factor labels. The external factor label data may be data in which, in addition to the ranges of values of the external factor data and the external factor labels, data indicating the type of the external factor (temperature herein) and data indicating the type of the feature (amplitude value herein) are associated with each other.

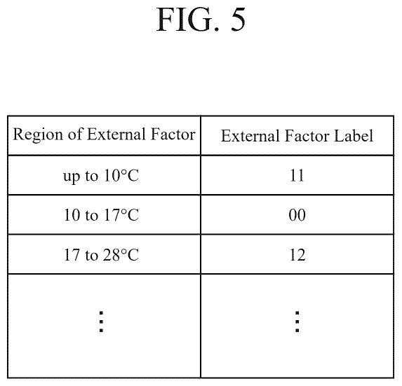

FIG. 5 is a diagram for explaining a concept of an example of the contents of external factor label data created by the external factor label data creating unit 13 in the first embodiment.

The external factor label data illustrated in FIG. 5 is external factor label data created after the external factor label data creating unit 13 assigns external factor labels as illustrated in FIG. 4.

Note that, in the external factor label data illustrated in FIG. 5, an external factor label “11” is an external factor label indicating that the range is a constant band (in which the relationship between the feature and the external factor data is constant) and is a range in which it is estimated that the same first diagnostic model can be used. Meanwhile, an external factor label “12” is an external factor label indicating that the range is a constant band (in which the relationship between the feature and the external factor data is constant) and is a range in which it is estimated that the same second diagnostic model can be used. Further, an external factor label “00” is an external factor label indicating that the range is a transition band, and, in other words, is a range in which the relationship between the feature and the external factor data is estimated to change frequently.

The external factor label data creating unit 13 stores the created external factor label data into the external factor label data storing unit 42 of the storage device 4.

On the basis of the external factor label data created by the external factor label data creating unit 13, the diagnostic model creating unit 21 acquires, from the training data storing unit 41 of the storage device 4, the training data corresponding to the range of values of the external factor data associated with the external factor label indicating that the range is a range in which the relationship between the external factor data in the range and the feature is estimated to be constant.

Assuming that the external factor label data is external factor label data having contents as illustrated in FIG. 5, the diagnostic model creating unit 21 acquires, from the training data storing unit 41, training data having the external factor data indicating the range less than 10° C. added thereto, as the training data for creating the first diagnostic model. Also, the diagnostic model creating unit 21 acquires, from the training data storing unit 41, training data having the external factor data indicating the range from 17° C. or more to less than 28° C. added thereto, as the training data for creating the second diagnostic model.

In this manner, in a case where there are ranges of values of the external factor data to which different external factor labels are assigned, the diagnostic model creating unit 21 acquires training data for each range of values of the external factor data.

The diagnostic model creating unit 21 creates a diagnostic model using the acquired training data.

In the above example, the diagnostic model creating unit 21 creates the first diagnostic model using the training data to which the external factor data indicating the range less than 10° C. is added, and creates the second diagnostic model using the training data to which the external factor data indicating the range from 17° C. or more to less than 28° C. is added.

In the first embodiment, a diagnostic model is assumed to be a model that receives a feature as an input and outputs a value indicating the state of the target apparatus. The value indicating the state of the target apparatus is a value indicating the degree of degradation of the target apparatus.

The diagnostic model creating unit 21 may create a diagnostic model, using a known technique such as supervised learning or unsupervised learning.

Note that the diagnostic model creating unit 21 does not create any diagnostic model from the training data corresponding to the range of values of the external factor data associated with an external factor label indicating that it is a range in which the relationship between the external factor data in the range and the feature is estimated to change frequently.

A reliability determining unit 211 included in the diagnostic model creating unit 21 determines the reliability of the diagnostic model created by the diagnostic model creating unit 21.

For example, the reliability determining unit 211 determines the reliability of the diagnostic model on the basis of the number of pieces of training data used in the creation of the diagnostic model by the diagnostic model creating unit 21.

For example, the administrator or the like creates beforehand a condition (hereinafter referred to as a “reliability determining condition”) on how many pieces of training data should be used to determine the reliability, and the condition is stored in a place that can be referred to by the diagnostic model creation device 2. The administrator or the like creates the reliability determining condition in such a manner that the reliability of a diagnostic model created with a larger number of pieces of training data is higher. Note that a higher reliability indicates that the diagnostic model having the reliability determined is more reliable, or, in other words, is more accurate.

Note that the reliability determining unit 211 performs reliability determination for each diagnostic model.

The diagnostic model creating unit 21 stores the created diagnostic model into the diagnostic model storing unit 43.

At this point of time, the diagnostic model creating unit 21 associates the diagnostic model with the data indicating the range of values of the external factor data corresponding to the diagnostic model and the reliability determined by the reliability determining unit 211. The diagnostic model creating unit 21 may further associate the diagnostic model with the data indicating the feature to be input.

Next, the degradation diagnostic device 3 according to the first embodiment is described.

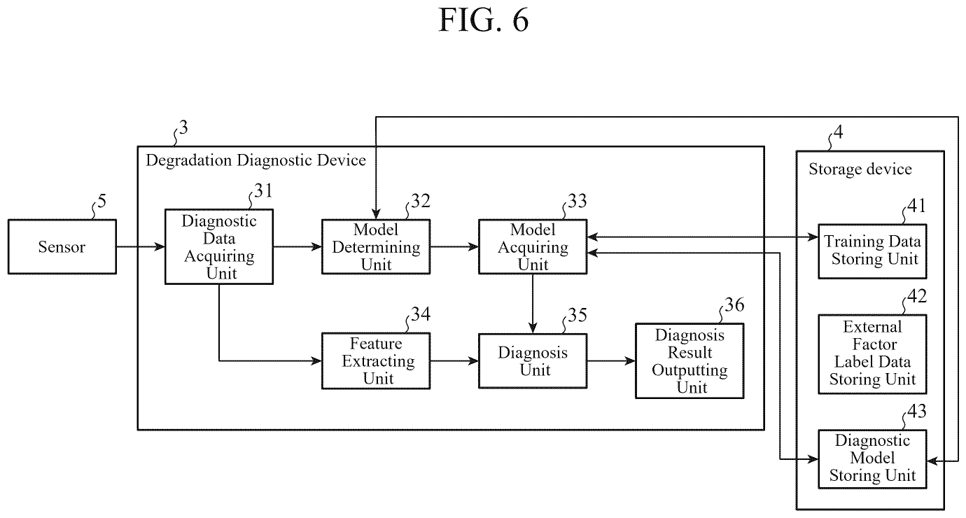

FIG. 6 is a diagram illustrating an example configuration of the degradation diagnostic device 3 according to the first embodiment.

The degradation diagnostic device 3 includes a diagnostic data acquiring unit 31, a model determining unit 32, a model acquiring unit 33, a feature extracting unit 34, a diagnosis unit 35, and a diagnosis result outputting unit 36.

The diagnostic data acquiring unit 31 acquires, from the sensor 5, diagnostic data including sensor data (vibration data herein) related to the operating state of the target apparatus and external factor data (temperature data herein) related to the operating environment of the target apparatus.

The diagnostic data acquiring unit 31 outputs the external factor data among the acquired diagnostic data to the model determining unit 32, and outputs the sensor data to the feature extracting unit 34.

The model determining unit 32 determines the diagnostic model to be used in degradation diagnosis, on the basis of the external factor data acquired by the diagnostic data acquiring unit 31 and the data indicating the range of values of the external factor data associated with the diagnostic model.

The model determining unit 32 refers to the diagnostic model storing unit 43 of the storage device 4, and determines the diagnostic model.

For example, it is assumed that the external factor data is external factor data indicating an external factor (temperature herein) of 18° C. Also, it is assumed that the second diagnostic model stored in the diagnostic model storing unit 43 is associated with data indicating 17° C. to 28° C. as the range of values of the external factor data.

In this case, the model determining unit 32 determines the second diagnostic model to be the diagnostic model to be used in degradation diagnosis.

Note that, as described above, the diagnostic model creating unit 21 of the diagnostic model creation device 2 does not create any diagnostic model based on the training data corresponding to the range of values of the external factor data to which an external factor label is assigned, the external factor label indicating that the range is a transition band or is a range in which the relationship between the external factor data in the range and the feature is estimated to change frequently. That is, depending on the value of the external factor data, the corresponding diagnostic model might not be created.

In this case, the model determining unit 32 determines that the diagnostic model to be used in degradation diagnosis has not been created.

The model determining unit 32 outputs, to the model acquiring unit 33, data (hereinafter referred to as the “model identifying data”) from which the diagnostic model determined to be used in degradation diagnosis can be identified. Note that data (an ID, for example) from which the diagnostic model can be identified by the diagnostic model creating unit 21 at the time of creating the diagnostic model is added to the diagnostic model.

In a case where it is determined that the diagnostic model to be used in degradation diagnosis has not been created, the model determining unit 32 outputs, to the model acquiring unit 33, data (hereinafter referred to as the “model uncreation notification”) for notifying that the diagnostic model has not been created.

In a case where the model identifying data is output from the model determining unit 32, the model acquiring unit 33 acquires the diagnostic model determined to be used in degradation diagnosis by the model determining unit 32, from the diagnostic model storing unit 43 of the storage device 4.

In a case where the model uncreation notification is output from the model determining unit 32, the model acquiring unit 33 creates the diagnostic model to be used in degradation diagnosis.

The creation of the diagnostic model by the model acquiring unit 33 is now described in detail.

On the basis of the value of the external factor data acquired by the diagnostic data acquiring unit 31, the model acquiring unit 33 refers to the training data storing unit 41 of the storage device 4, to acquire the training data in which external factor data around the external factor data and the features are associated. Note that the model acquiring unit 33 can acquire the external factor data from the diagnostic data acquiring unit 31 via the model determining unit 32.

The condition (hereinafter referred to as the “external-factor-data acquiring condition”) as to which external factor data is to be data around the external factor data acquired by the diagnostic data acquiring unit 31 is created beforehand by the administrator or the like, and is stored in a place that can be referred to by the degradation diagnostic device 3.

As the external-factor-data acquiring condition, a condition that “external factor data in the range of 0.1° C. of the value of the external factor data acquired by the diagnostic data acquiring unit 31 is set as the data around the external factor” is set, for example. In this case, if the value of the external factor data acquired by the diagnostic data acquiring unit 31 is 16° C., for example, the model acquiring unit 33 acquires, from the training data storing unit 41, the training data in which the external factor data indicating values between 15.9° C. and 16.1° C. and the feature are associated.

Alternatively, as the external-factor-data acquiring condition, a condition that “external factor data of ten values close to the value of the external factor data acquired by the diagnostic data acquiring unit 31 in order of closeness to the value is set as the data around the external factor” may be set, for example. In this case, if the value of the external factor data acquired by the diagnostic data acquiring unit 31 is 16° C., for example, the model acquiring unit 33 identifies ten pieces of external factor data having values around 16° C. and close to 16° C., and acquires, from the training data storing unit 41, the training data in which the identified external factor data and the feature are associated with each other.

After acquiring the training data, the model acquiring unit 33 creates a diagnostic model, on the basis of the acquired training data.

The model acquiring unit 33 may create a diagnostic model by the same method as the method by which the diagnostic model creating unit 21 of the diagnostic model creation device 2 creates a diagnostic model.

Further, after creating the diagnostic model, the model acquiring unit 33 determines the reliability of the created diagnostic model. The model acquiring unit 33 may determine the reliability of the diagnostic model by the same method as the method by which the reliability determining unit 211 of the diagnostic model creation device 2 determines the reliability of a diagnostic model.

As described above, in a case where the diagnostic model to be used in degradation diagnosis has not been created, the model acquiring unit 33 creates a diagnostic model each time on the basis of the local training data, in accordance with the external-factor-data acquiring condition.

Note that, as described above, the external factor data is time-series data.

The model acquiring unit 33 performs a process of acquiring the corresponding diagnostic model for the external factor data in time series.

Further, after completing the acquisition of the corresponding diagnostic model for the external factor data, the model acquiring unit 33 creates data (hereinafter referred to as the “applicable model range data”) in which the acquisition date and time of the external factor data and data for identifying the corresponding diagnostic model are associated with each other in time series.

Note that the acquisition date and time of the external factor data is added to the external factor data.

The model acquiring unit 33 outputs, to the diagnosis unit 35, the diagnostic model acquired by referring to the diagnostic model storing unit 43 or the diagnostic model acquired by creating it on the basis of the training data acquired from the training data storing unit 41, together with the created applicable model range data.

In a case where the diagnostic model has been created, the model acquiring unit 33 associates the diagnostic model with the data indicating the value of the external factor data corresponding to the diagnostic model and the determined reliability. The model acquiring unit 33 may further associate the diagnostic model with the data indicating the feature to be input.

The feature extracting unit 34 extracts the feature from the sensor data acquired by the diagnostic data acquiring unit 31.

More specifically, the feature extracting unit 34 extracts the feature to be input to the diagnostic model, from the sensor data acquired by the diagnostic data acquiring unit 31.

Note that, the administrator or the like creates data (hereinafter referred to as the “feature defining data”) for identifying the feature to be input to the diagnostic model to be used in degradation diagnosis on the target apparatus in the degradation diagnostic device 3, and holds the data in a buffer or the like of the feature extracting unit 34. The feature extracting unit 34 determines what kind of feature to be extracted, in accordance with the feature defining data.

Here, the feature to be input to the diagnostic model is amplitude value. The feature extracting unit 34 extracts the amplitude value of vibration as the feature.

The feature extracting unit 34 may extract the feature from the sensor data by a known feature extracting method.

The feature extracting unit 34 outputs the extracted feature to the diagnosis unit 35.

On the basis of the feature extracted by the feature extracting unit 34, the diagnosis unit 35 performs degradation diagnosis on the target apparatus, using the diagnostic model acquired by the model acquiring unit 33.

First, the diagnosis unit 35 determines which diagnostic model corresponds to the feature extracted by the feature extracting unit 34 among the diagnostic models output from the model acquiring unit 33.

Specifically, on the basis of the feature extracted by the feature extracting unit 34, the diagnosis unit 35 sets the diagnostic model acquired by the model acquiring unit 33 with respect to the external factor data corresponding to the feature, as the diagnostic model corresponding to the feature extracted by the feature extracting unit 34, or as the diagnostic model to be used in the degradation diagnosis on the target apparatus based on the feature extracted by the feature extracting unit 34.

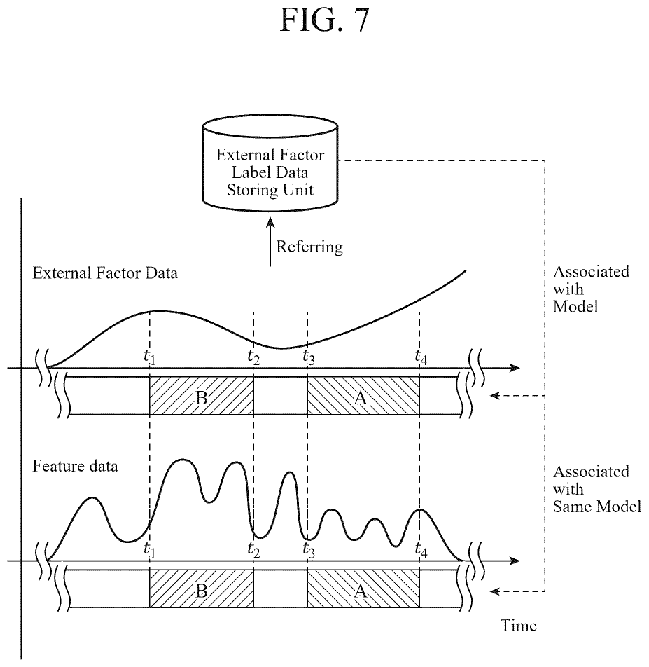

Here, FIG. 7 is a diagram for explaining an example of a method by which the diagnosis unit 35 determines the diagnostic model corresponding to the feature extracted by the feature extracting unit 34 among the diagnostic models output from the model acquiring unit 33 in the first embodiment.

As described above, the sensor data and the external factor data are time-series data. That is, the sensor data and the external factor data are associated with the acquisition dates and times of the data. Note that the acquisition dates and times of the data are assigned to the respective pieces of the sensor data and the external factor data.

The diagnosis unit 35 matches the acquisition dates and times of the data included in the applicable model range data with the acquisition dates and times of the data added to the feature on the basis of the applicable model range data output from the model acquiring unit 33, to determine which diagnostic model is used for the feature in which time period.

For example, as illustrated in FIG. 7, in the applicable model range data, a diagnostic model “B” is associated with the external factor data in the time period from time t1 to time t2.

In this case, the diagnosis unit 35 determines that the diagnostic model to be used in degradation diagnosis on the target apparatus by inputting the feature of the time period from time t1 to time t2 is the diagnostic model “B”.

In such a manner, the diagnosis unit 35 determines that the diagnostic model acquired on the basis of the external factor data of the corresponding data acquisition date and time for the feature extracted by the feature extracting unit 34 is the diagnostic model to be used in the degradation diagnosis on the target apparatus based on the feature.

After determining the diagnostic model to be used in degradation diagnosis on the target apparatus based on the feature extracted by the feature extracting unit 34, the diagnosis unit 35 performs degradation diagnosis on the target apparatus, using the diagnostic model. Note that the diagnostic model has been output from the model acquiring unit 33. The diagnosis unit 35 can identify the diagnostic model, on the basis of the data for identifying the diagnostic models included in the applicable model range data.

For example, the diagnosis unit 35 compares the value indicating the state of the target apparatus as obtained by inputting the feature to the diagnostic model with a preset threshold (hereinafter referred to as the “degradation diagnostic threshold”), and diagnoses that the target apparatus has been degraded in a case where the value indicating the state of the target apparatus is equal to or higher than the degradation diagnostic threshold. In a case where the value indicating the state of the target apparatus is smaller than the degradation diagnostic threshold, the diagnosis unit 35 diagnoses that the target apparatus has not been degraded.

The diagnosis unit 35 may perform degradation diagnosis on the target apparatus by determining the degree of degradation of the target apparatus, instead of performing degradation diagnosis on the target apparatus depending on whether the target apparatus has been degraded.

For example, the diagnosis unit 35 determines the degree of device degradation indicating the degree of degradation of the target apparatus, depending on the value indicating the state of the target apparatus obtained by inputting the feature to the diagnostic model. Note that it is assumed that a condition indicating how high the degree of degradation of the target apparatus when the value indicating the state of the target apparatus is how high is created beforehand and is held in a buffer or the like of the diagnosis unit 35.

The diagnosis unit 35 outputs a result of the degradation diagnosis on the target apparatus (the result will be hereinafter referred to as the “degradation diagnosis result”) to the diagnosis result outputting unit 36.

At this point of time, the diagnosis unit 35 outputs the diagnostic model used in the degradation diagnosis on the target apparatus to the diagnosis result outputting unit 36, the diagnostic model being associated with the degradation diagnosis result.

The diagnosis result outputting unit 36 outputs the degradation diagnosis result to an output device.

At this point of time, the diagnosis result outputting unit 36 may output the reliability of the diagnostic model used in the degradation diagnosis on the target apparatus to the output device, together with the degradation diagnosis result.

The diagnosis result outputting unit 36 may output the data for identifying the diagnostic model used in the degradation diagnosis on the target apparatus to the output device, together with the degradation diagnosis result.

The reliability of the diagnostic model and the data for identifying the diagnostic model have been given to the diagnostic model. On the basis of the diagnostic model output from the diagnosis unit 35, the diagnosis result outputting unit 36 can determine the reliability of the diagnostic model and the data for identifying the diagnostic model.

When the diagnosis result outputting unit 36 outputs the degradation diagnosis result to the output device, the output device displays or audibly outputs the degradation diagnosis result.

The operator or the like can grasp whether the target apparatus has been degraded or the degree of degradation of the target apparatus, for example, by checking the displayed or audibly-output result of the degradation diagnosis on the target apparatus.

Further, in a case where the diagnosis result outputting unit 36 outputs the reliability, the output device may display or audibly output the reliability, together with the result of the degradation diagnosis on the target apparatus. As a result, in a case where the reliability is low, for example, the operator or the like can grasp the certainty of the degradation diagnosis result and take an appropriate measure, such as inspecting the target apparatus in an early stage just in case, even if the target apparatus has been diagnosed as not being degraded.

Further, in a case where the diagnosis result outputting unit 36 outputs the diagnostic model used in the degradation diagnosis, the output device may display or audibly output the data for identifying the diagnostic model, together with the result of the degradation diagnosis on the target apparatus. As a result, the operator or the like can analyze the diagnostic model, for example.

Operations to be performed by the diagnostic model creation device 2 including the label creation device 1, and the degradation diagnostic device 3 are now described.

First, operations to be performed by the label creation device 1 and the diagnostic model creation device 2 are described.

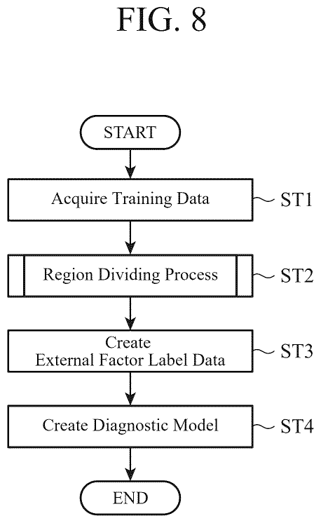

FIG. 8 is a flowchart for explaining operations to be performed by the diagnostic model creation device 2 according to the first embodiment including the label creation device 1 according to the first embodiment.

After receiving an operation starting instruction, the diagnostic model creation device 2 starts an operation as illustrated in the flowchart in FIG. 8. For example, the operator or the like inputs an operation starting instruction from a PC in the management room. After receiving the operation starting instruction, a control unit (not illustrated) of the diagnostic model creation device 2 causes the label creation device 1 and the diagnostic model creating unit 21 to start operating.

As for the operations illustrated in the flowchart in FIG. 8, an operation including the processes in steps ST1 to ST3 is an operation to be performed by the label creation device 1, and an operation including the process in step ST4 is an operation to be performed by the diagnostic model creation device 2.

The training data acquiring unit 11 refers to the training data storing unit 41, and acquires training data (step ST1).

The training data acquiring unit 11 outputs the acquired training data to the external factor region dividing unit 12.

On the basis of the training data output from the training data acquiring unit 11 in step ST1, the external factor region dividing unit 12 performs a region dividing process of classifying a constant band and a transition band in the range of values of external factor data in the axial direction of the external factor data (step ST2).

The external factor region dividing unit 12 outputs the region setting data to the external factor label data creating unit 13.

On the basis of the region setting data output from the external factor region dividing unit 12 in step ST2, the external factor label data creating unit 13 assigns an external factor label indicating that the range is a constant band to the range of values of external factor data classified as a constant band, and an external factor label indicating that the range is a transition band to the range of values of external factor data classified as a transition band, with respect to the axis of the external factor data.

After assigning the external factor labels, the external factor label data creating unit 13 creates external factor label data (step ST3).

The external factor label data creating unit 13 stores the created external factor label data into the external factor label data storing unit 42 of the storage device 4.

On the basis of the external factor label data created by the external factor label data creating unit 13 in step ST3, the diagnostic model creating unit 21 acquires, from the training data storing unit 41 of the storage device 4, the training data corresponding to the range of values of the external factor data associated with the external factor label indicating that the range is a range in which the relationship between the external factor data in the range and the feature is constant. The diagnostic model creating unit 21 then creates a diagnostic model using the acquired training data (step ST4).

Note that, in step ST4, the reliability determining unit 211 included in the diagnostic model creating unit 21 determines the reliability of the diagnostic model.

The diagnostic model creating unit 21 stores the created diagnostic model into the diagnostic model storing unit 43.

At this point of time, the diagnostic model creating unit 21 associates the diagnostic model with the data indicating the range of values of the external factor data corresponding to the diagnostic model and the reliability determined by the reliability determining unit 211. The diagnostic model creating unit 21 may further associate the diagnostic model with the data indicating the feature to be input.

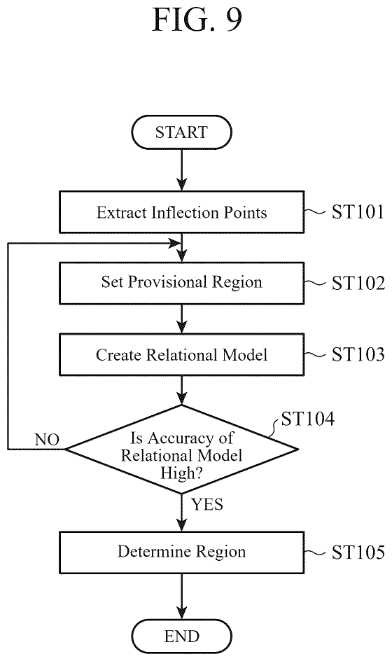

FIG. 9 is a flowchart for explaining details of the region dividing process to be performed by the external factor region dividing unit 12 in step ST2 in FIG. 8.

First, on the basis of the training data output from the training data acquiring unit 11, the inflection point extracting unit 121 extracts a plurality of inflection points in the axial direction of the external factor data associated with the feature in the training data (step ST101).

The inflection point extracting unit 121 outputs the inflection-point-added training data to the external factor region dividing unit 12.

On the basis of the inflection-point-added training data output from the inflection point extracting unit 121, the provisional region setting unit 122 selects the first inflection point and the second inflection point. The provisional region setting unit 122 sets the range of values of the external factor data between the selected first inflection point and second inflection point as an inflection point range, and sets a provisional region to be a candidate for a constant band within the inflection point range (step ST101).

The provisional region setting unit 122 outputs the value of the external factor data in the set provisional region and the value of the feature corresponding to the value of the external factor data, to the relational model creating unit 123.

On the basis of the values of the external factor data in the provisional region and the values of the feature corresponding to the values of the external factor data, the relational model creating unit 123 creates a relational model (step ST103).

The relational model creating unit 123 outputs the created relational model to the relational model evaluating unit 124, together with the values of the external factor data in the provisional region and the values of the feature corresponding to the values of the external factor data output from the provisional region setting unit 122.

The relational model evaluating unit 124 evaluates the accuracy of the relational model using the values of the external factor data included in the provisional region and the values of the feature corresponding to the values of the external factor data, and outputs the result of the evaluation of the relational model to the region determining unit 125, together with the values of the external factor data in the provisional region and the values of the feature corresponding to the values of the external factor data, or, in other words, together with the training data in the provisional region.

On the basis of the result of the evaluation of the relational model output from the relational model evaluating unit 124, the region determining unit 125 determines whether the relational model is evaluated to have a sufficiently high accuracy (step ST104).

If it is determined that the accuracy of the relational model is evaluated to be sufficiently high (if “YES” in step ST104), the region determining unit 125 determines to classify the provisional region in which the accuracy of the relational model is evaluated to be high as a constant band. The region determining unit 125 then determines to classify a range of values of the external factor data other than the determined constant band as a transition band in the inflection point range (step ST105).

The external factor region dividing unit 12 outputs the region setting data to the external factor label data creating unit 13.

If it is determined that the accuracy of the relational model is not evaluated to be sufficiently high, or the accuracy of the relational model is evaluated to be low (if “NO” in step ST104), on the other hand, the region determining unit 125 outputs an instruction to the provisional region setting unit 122 to narrow the range of the provisional region and re-set the provisional region. The provisional region setting unit 122 re-sets the provisional region, on the basis of the instruction from the region determining unit 125. Specifically, the provisional region setting unit 122 narrows the range of values of the external factor data at both ends of the provisional region, and re-sets the provisional region. The operation of the external factor region dividing unit 12 returns to the process in step ST102.

Note that, in step ST104, the region determining unit 125 determines whether the provisional region set by the provisional region setting unit 122 is smaller than the minimum provisional region range, and, if the provisional region set by the provisional region setting unit 122 is smaller than the minimum provisional region range, the region determining unit 125 determines that the provisional region cannot be set as a constant band even if the relational model is evaluated to have a sufficiently high accuracy, and classifies the provisional region as a transition band. The region determining unit 125 then determines to classify a range of values of the external factor data other than the provisional region as a transition band in the inflection point range. The external factor region dividing unit 12 outputs the region setting data to the external factor label data creating unit 13. The operation of the external factor region dividing unit 12 then ends the operation as illustrated in the flowchart in FIG. 9.

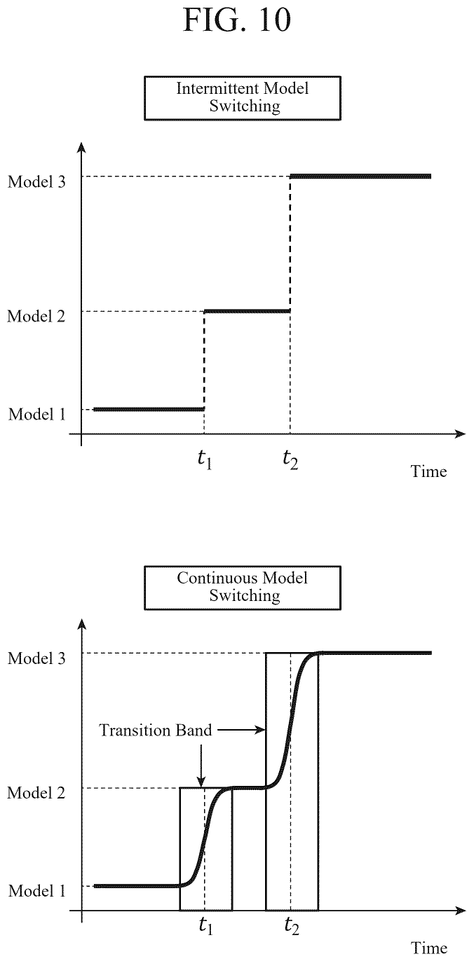

As in the technique disclosed in Patent Literature 1 mentioned above, in a case where a model is created for an operating condition of an apparatus, the index of the operating condition is less likely to have continuous values, and accordingly, the accuracy of a diagnosis result is less likely to decrease at the boundary of model switching. That is, a plurality of models can be clearly switched, depending on the sensor data acquired from the apparatus. (See the upper graph in the upper portion of FIG. 10)

However, the index of the operating environment is likely to have continuous values. In this case, there is a possibility that a highly accurate diagnosis result cannot be obtained even if any of the models before and after the switching is used at the boundary of the model switching. (See the lower graph in the lower portion of FIG. 10. Note that the point of time at which there is a possibility that a highly accurate diagnosis result cannot be obtained even if any of the models is used is shown as a transition band.)

By a conventional technique, it is difficult to construct a model takin into consideration that there is a possibility that an accurate diagnosis result cannot be obtained even if any of the models before and after switching is used, due to the operating environment.

On the other hand, the label creation device 1 acquires training data having a feature and external factor data associated therewith, and, on the basis of the acquired training data, classifies the range of values of external factor data in the axial direction of the external factor data into a constant band that is a range of values of external factor data whose relationship with the corresponding feature is estimated to be constant, and a transition band that is a range of values of external factor data whose relationship with the corresponding feature is estimated to change frequently. With respect to the axis of external factor data, the label creation device 1 then assigns an external factor label indicating that the range is a range in which the relationship with the feature corresponding to the external factor data in the range is constant to the range of values of the external factor data classified as a constant band, assigns an external factor label indicating that the range is a range in which the relationship with the feature corresponding to the external factor data in the range changes frequently to the range of values of the external factor data classified as a transition band, and creates external factor label data in which the ranges of values of the external factor data are associated with the external factor labels.

Thus, the label creation device 1 can provide data that assists in construction of a diagnostic model that prevents a decrease in accuracy of diagnosis on degradation of the target apparatus due to the operating environment. As a result, the label creation device 1 can contribute to construction of a diagnostic model that prevents a decrease in accuracy of diagnosis on degradation of the target apparatus due to the operating environment, and can contribute to achieving accurate degradation diagnosis with the diagnostic model. Also, the label creation device 1 can contribute to shortening of the time for designing a diagnostic model.

Further, in creating the external factor label data, the label creation device 1 focuses on the relationship between the feature based on the sensor data in a normal state of the target apparatus and the external factor, or, in other words, the training data to be used by the label creation device 1 creating the external factor label data is only required to be data corresponding to at least the relationship between the feature based on the sensor data in a normal state of the target apparatus and the external factor. Accordingly, it is possible to reduce the work required for creating training data. Normally, preparing training data based on the sensor data in an abnormal state requires more efforts than preparing training data based on the sensor data in a normal state.

Further, by providing the external factor data, the label creation device 1 can cause the operator or the like to clearly grasp which external factor causes the diagnostic model to switch at which timing, for example.

On the basis of the external factor label data created by the label creation device 1, the diagnostic model creation device 2 acquires the training data corresponding to the range of values of the external factor data associated with the external factor label indicating that the range is a range in which the relationship between the external factor data in the range and the corresponding feature is constant, and creates a diagnostic model using the acquired training data.

By creating a diagnostic model on the basis of the external factor label data created by the label creation device 1, the diagnostic model creation device 2 can construct a diagnostic model that prevents a decrease in accuracy of diagnosis on degradation of an apparatus due to the operating environment.

Next, an operation of the degradation diagnostic device 3 is described.

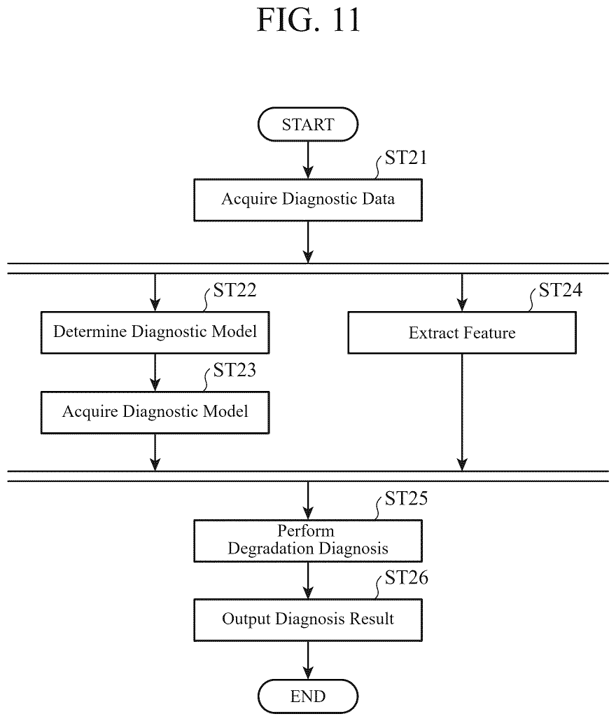

FIG. 11 is a flowchart for explaining an operation of the degradation diagnostic device 3 according to the first embodiment.

After receiving an instruction to start degradation diagnosis on the target apparatus, the degradation diagnostic device 3 starts an operation as illustrated in the flowchart in FIG. 11. For example, the operator or the like inputs an instruction to start degradation diagnosis on the target apparatus, from a PC in the management room. After receiving the instruction to start degradation diagnosis on the target apparatus, a control unit (not illustrated) of the degradation diagnostic device 3 causes the diagnostic data acquiring unit 31, the model determining unit 32, the model acquiring unit 33, the feature extracting unit 34, the diagnosis unit 35, and the diagnosis result outputting unit 36 to start operating.

The diagnostic data acquiring unit 31 acquires diagnostic data from the sensor 5 (step ST21).

The diagnostic data acquiring unit 31 outputs the external factor data among the acquired diagnostic data to the model determining unit 32, and outputs the sensor data to the feature extracting unit 34.

The model determining unit 32 determines the diagnostic model to be used in degradation diagnosis, on the basis of the external factor data acquired by the diagnostic data acquiring unit 31 in step ST21 and the data indicating the range of values of the external factor data associated with the diagnostic model (step ST22).

The model determining unit 32 outputs the model identifying data to the model acquiring unit 33. In a case where it is determined that the diagnostic model to be used in degradation diagnosis has not been created, the model determining unit 32 outputs the model uncreation notification to the model acquiring unit 33.

In a case where the model identifying data is output from the model determining unit 32 in step ST22, the model acquiring unit 33 acquires the diagnostic model determined to be used in degradation diagnosis by the model determining unit 32, from the diagnostic model storing unit 43 of the storage device 4. In a case where a model uncreation notification is output from the model determining unit 32 in step ST22, and in a case where data indicating that a diagnostic model has not been created is output, the model acquiring unit 33 acquires a diagnostic model by creating the diagnostic model to be used in degradation diagnosis (step ST23).

Further, after completing the acquisition of the corresponding diagnostic model for the external factor data, the model acquiring unit 33 creates the applicable model range data.

The model acquiring unit 33 outputs, to the diagnosis unit 35, the diagnostic model acquired by referring to the diagnostic model storing unit 43 or the diagnostic model acquired by creating it on the basis of the training data acquired from the training data storing unit 41, together with the created applicable model range data.

The feature extracting unit 34 extracts the feature from the sensor data acquired by the diagnostic data acquiring unit 31 in step ST21 (step ST24).

The feature extracting unit 34 outputs the extracted feature to the diagnosis unit 35.

On the basis of the feature extracted by the feature extracting unit 34 in step ST24, the diagnosis unit 35 performs degradation diagnosis on the target apparatus, using the diagnostic model acquired by the model acquiring unit 33 in step ST23 (step ST25).

The diagnosis unit 35 outputs the degradation diagnosis result to the diagnosis result outputting unit 36.

At this point of time, the diagnosis unit 35 outputs the diagnostic model used in the degradation diagnosis on the target apparatus to the diagnosis result outputting unit 36, the diagnostic model being associated with the degradation diagnosis result.

The diagnosis result outputting unit 36 outputs the degradation diagnosis result to the output device (step ST26).

At this point of time, the diagnosis result outputting unit 36 may output the reliability of the diagnostic model used in the degradation diagnosis on the target apparatus to the output device, together with the degradation diagnosis result.

The diagnosis result outputting unit 36 may output the data for identifying the diagnostic model used in the degradation diagnosis on the target apparatus to the output device, together with the degradation diagnosis result.

Note that, in the flowchart in FIG. 11, the processes in steps ST22 and ST23 and the process in step ST24 are performed in parallel, but this is merely an example.

For example, the process in step ST24 may be performed after the processes in steps ST22 and ST23, or vice versa.

It is only required to complete the processes in steps ST22 and ST23 and the process in step ST24 before the process in step ST25 is performed.

As described above, in the degradation diagnostic device 3, the diagnostic model creation device 2 performs degradation diagnosis on the target apparatus, using the diagnostic model created on the basis of the external factor label data created by the label creation device 1. The degradation diagnostic device 3 acquires the diagnostic data including the sensor data and the external factor data, and determines the diagnostic model to be used in degradation diagnosis, on the basis of the acquired external factor data and the data indicating the range of values of the external factor data associated with the diagnostic model. The degradation diagnostic device 3 acquires the diagnostic model determined to be used in degradation diagnosis.

Also, the degradation diagnostic device 3 extracts a feature from the acquired sensor data.

On the basis of the extracted feature, the degradation diagnostic device 3 then performs degradation diagnosis on the target apparatus, using the diagnostic model acquired for the external factor data corresponding to the feature. The degradation diagnostic device 3 outputs the result of the degradation diagnosis performed on the target apparatus.

The degradation diagnostic device 3 performs degradation diagnosis on the target apparatus using the diagnostic model created by taking into account the possibility that an accurate diagnosis result cannot be obtained before and after switching due to the operating environment, and thus, can perform accurate degradation diagnosis.

Further, in a case where the diagnostic model to be used in degradation diagnosis has not been created, the degradation diagnostic device 3 creates a diagnostic model each time on the basis of local training data, in accordance with the external-factor-data acquiring condition.

By creating a diagnostic model using only the local training data, the degradation diagnostic device 3 can create a diagnostic model compatible with the characteristics of a transition band in which the optimal diagnostic model frequently changes.

Note that, in the first embodiment described so far, for ease of explanation, the label creation device 1 has been described as a device that creates external factor label data for a set of data of one type of feature (amplitude value) and one type of external factor (temperature), but this is merely an example.

For example, the training data may be data in which features are associated with external factor data related to external factors of a plurality of different kinds, such as temperature and precipitation.

Also, the feature may be a plurality of different kinds of feature, such as amplitude value, variance, and standard deviation.

In the label creation device 1, in the training data to be acquired by the training data acquiring unit 11, the external factor data related to a plurality of different kinds of external factors can be associated with the feature for each external factor. Also, in the training data to be acquired by the training data acquiring unit 11, a plurality of features may be associated with one external factor.

The label creation device 1 creates the external factor label data for each set of external factor data and a feature.

Specifically, in the label creation device 1, the external factor region dividing unit 12 classifies a constant band and a transition band in the range of values of external factor data for each set of external factor data and a feature, and the external factor label data creating unit 13 creates the external factor label data by assigning an external factor label indicating the constant band or the transition band to the axis of the external factor data for each set of external factor data and a feature.

For example, it is assumed that features as inputs to the diagnostic model are “amplitude value” and “variance”, with respect to the external factor “temperature”.

In this case, the label creation device 1 creates external factor data for each of a set of “temperature” and “amplitude value” and a set of “temperature” and “variance”.

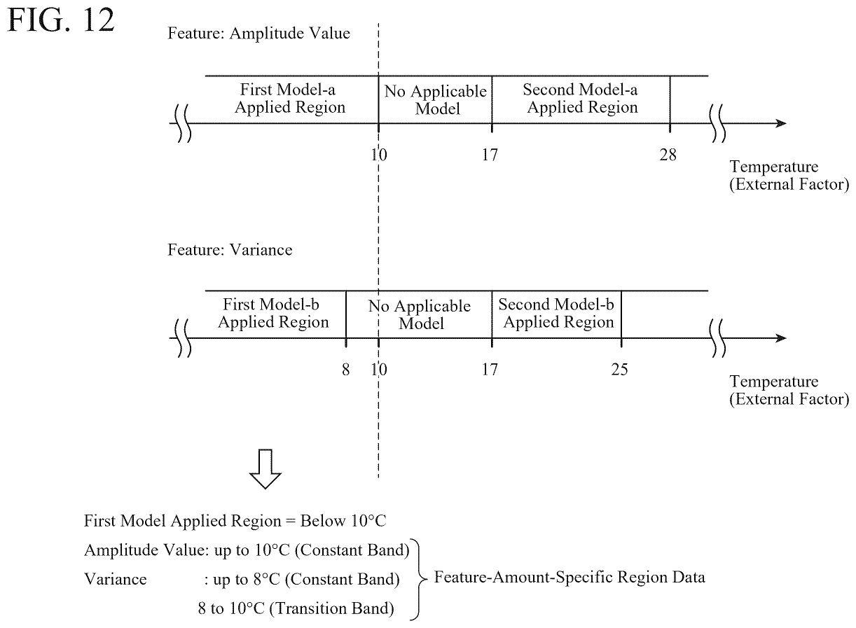

FIG. 12 is a diagram for explaining a concept of an example of external factor labels assigned to the axis of external factor data by the external factor label data creating unit 13 in the label creation device 1 in a case where the label creation device 1 creates external factor data for each of a set of “temperature” and “amplitude value” and a set of “temperature” and “variance” in the first embodiment.

In FIG. 12, regarding an external factor (temperature herein) in the set of “temperature” and “amplitude value”, the range less than 10° C. is classified as a constant band, the range from 10° C. or more to less than 17° C. is classified as a transition band, and the range from 17° C. or more to less than 28° C. is classified as a constant band by the external factor region dividing unit 12.

In this case, with respect to the axis of the external factor data, the external factor label data creating unit 13 assigns an external factor label indicating that the range less than 10° C. is a constant band (in which the relationship between the feature and the external factor data is constant) and is a range in which it is estimated that the same diagnostic model (hereinafter referred to as the “first diagnostic model”) can be used. In FIG. 4, the external factor label is shown as “first model applied region”. In FIG. 12, the external factor label is shown as “first model—a applied region”.

Also, the external factor label data creating unit 13 assigns an external factor label indicating that the range from 10° C. or more to less than 17° C. in the axial direction of the external factor data is a transition band. In FIG. 12, the external factor label is shown as “no applicable model”.

Also, in the axial direction of the external factor data, the external factor label data creating unit 13 assigns an external factor label indicating that the range from 17° C. or more to less than 28° C. is a constant band (in which the relationship between the feature and the external factor data is constant) and is a range in which it is estimated that the same diagnostic model (second diagnostic model) different from the first diagnostic model can be used. In FIG. 12, the external factor label is shown as “second model-a applied region”.

Also, regarding the external factor (temperature) in the set of “temperature” and “variance”, the range less than 8° C. is classified as a constant band, the range from 8° C. or more and less than 17° C. is classified as a transition band, and the range from 17° C. or more to less than 25° C. is classified as a constant band by the external factor region dividing unit 12.

In this case, with respect to the axis of the external factor data, the external factor label data creating unit 13 assigns an external factor label indicating that the range less than 8° C. is a constant band (in which the relationship between the feature and the external factor data is constant) and is a range in which it is estimated that the same diagnostic model (first diagnostic model) can be used. In FIG. 12, the external factor label is shown as “first model-b applied region”.

Also, the external factor label data creating unit 13 assigns an external factor label indicating that the range from 8° C. or more and less than 17° C. is a transition band, with respect to the axis of the external factor data. In FIG. 12, the external factor label is shown as “no applicable model”.

Also, with respect to the axis of the external factor data, the external factor label data creating unit 13 assigns an external factor label indicating that the range from 17° C. or more to less than 25° C. is a constant band (in which the relationship between the feature and the external factor data is constant), and is a range in which it is estimated that the same diagnostic model (second diagnostic model) different from the first diagnostic model can be used. In FIG. 12, the external factor label is shown as “second model-b applied region”.

Note that, in the case of the above example, the range of values of the external factor data to which the external factor label indicating a constant band is assigned, and the range of values of the external factor data to which the external factor label indicating a transition band is assigned vary depending on the type of the feature.

As a specific example, to the range from 8° C. or more and less than 10° C., the external factor label “first model-a applied region” is assigned in the set of “temperature” and “amplitude value”, but the external factor label “no applicable model” is assigned in the set of “temperature” and “variance”.

In this manner, in a case where there is external factor label data corresponding to a plurality of features, and external factor label data to which external factor labels having different contents are assigned in a range of values of the same external factor data along the axis of the same external factor data, the range of values of the external factor data having a constant relationship with the corresponding feature is re-set for creating a diagnostic model, on the basis of the external factor label data created by the label creation device 1.

For example, the administrator or the like checks the external factor label data based on the external factor labels given as illustrated in FIG. 12, and determines to create the first diagnostic model for “temperature” less than 10° C., which is an external factor, for a diagnostic model having “amplitude value” and “variance” as inputs.

The administrator or the like re-sets the range less than 10° C. as the range of values of the external factor data in which it is estimated that the first diagnostic model can be used.

The administrator or the like then creates a condition (hereinafter referred to as the “diagnostic model creating condition”) for creating a diagnostic model, on the basis of the range of values of the external factor data in which it is estimated that the re-set first diagnostic model can be used.

The diagnostic model creating condition is data in a table format in which the re-set range of values of the external factor data, the external factor label in the re-set range of values of the external factor data, data indicating the features (“amplitude value” and “variance” in the above example) serving as inputs to the target diagnostic model set as an application region by an external factor label, and data (hereinafter referred to as the “feature-specific region data”) indicating whether the re-set range of values of the external factor data in the external factor label data originally created by the label creation device 1 for the features is a constant band or a transition band are associated with one another, for example.

In the above example, the administrator or the like creates a diagnostic model creating condition in which the data indicating that the range of “temperature” as an external factor is less than 10° C., the external factor label “first diagnostic model applied region”, and the feature-specific region data are associated with one another. In the feature-specific region data, the feature “amplitude value” is associated with data indicating that the range less than 10° C. is a constant band, and the feature “variance” is associated with data indicating that the range less than 8° C. is a constant band, and the range from 8° C. or more and less than 10° C. is a transition band (see FIG. 12).

The administrator or the like stores the created diagnostic model creating condition into the external factor label data storing unit 42.

In the diagnostic model creation device 2, in a case where the diagnostic model creating condition is stored in the external factor label data storing unit 42, the diagnostic model creating unit 21 creates a diagnostic model in accordance with the diagnostic model creating condition.

In the above example, the diagnostic model creating unit 21 determines to create the first diagnostic model for the external factor data less than 10° C. in accordance with the diagnostic model creating condition, and creates the first diagnostic model using the training data to which the external factor data less than 10° C. is added.

At this point of time, the reliability determining unit 211 may determine the reliability of the diagnostic model, on the basis of the feature-specific region data defined under the diagnostic model creating condition.

In the above example, the first diagnostic model is created from the training data to which the external factor data less than 10° C. is added. However, with respect to the feature “variance” extracted from the training data, the range from 8 degrees or more and less than 10° C. is originally the range of values of the external factor data to which the external factor label of a transition band is assigned in the label creation device 1.

For example, the reliability determining unit 211 determines the reliability to be low, for a diagnostic model created with the training data to which the external factor data having the external factor label of a transition band assigned thereto by the label creation device 1 is added as above. As for how low the reliability is to be determined, the reliability determining unit 211 may perform the determination, on the basis of the external factor data having the external factor label of a transition band assigned thereto by the label creation device 1, and the proportion of the given training data, for example.

Note that the above example is merely an example, and the reliability determining unit 211 may create another diagnostic model by setting the range less than 8° C. as a region in which “amplitude” and “variance” are used, and the range from 8° C. or more and less than 10° C. as a region in which only “amplitude” is used.

Note that, in a case where there is one set of a feature and an external factor, the administrator or the like may also create a diagnostic model creating condition after checking the external factor label data.

The administrator or the like can create an appropriate diagnostic model creating condition, on the basis of the external factor label data.

Further, in the first embodiment described above, the diagnostic model creating unit 21 of the diagnostic model creation device 2 includes the reliability determining unit 211, but this is merely an example. The diagnostic model creation device 2 does not necessarily have a function of determining the reliability of a diagnostic model.

In a case where the diagnostic model creation device 2 does not have a function of determining the reliability of a diagnostic model, the diagnostic model creation device 2 can be designed not to include the reliability determining unit 211.

Further, in the degradation diagnostic device 3, the model acquiring unit 33 does not necessarily have a function of determining reliability when creating a diagnostic model.

Also, in the first embodiment described so far, the label creation device 1 is included in the diagnostic model creation device 2, but this is merely an example.

The label creation device 1 and the diagnostic model creation device 2 may be devices independent of each other.

In this case, after receiving an operation starting instruction from the operator or the like, and accepting the operation starting instruction, a control unit (not illustrated) of the label creation device 1 causes the training data acquiring unit 11, the external factor region dividing unit 12, and the external factor label data creating unit 13 to start operating.

Also, in the first embodiment described so far, the label creation device 1, the diagnostic model creation device 2, and the degradation diagnostic device 3 are included in the target apparatus, but this is merely an example.

For example, in the label creation device 1, some or all of the training data acquiring unit 11, the external factor region dividing unit 12, and the external factor label data creating unit 13 may be included in a server or the like outside the target apparatus.

Also, the diagnostic model creating unit 21 of the diagnostic model creation device 2 may be included in a server or the like outside the target apparatus, for example.

Further, in the degradation diagnostic device 3, some or all of the diagnostic data acquiring unit 31, the model determining unit 32, the model acquiring unit 33, the feature extracting unit 34, the diagnosis unit 35, and the diagnosis result outputting unit 36 may be included in a server or the like outside the target apparatus, for example.

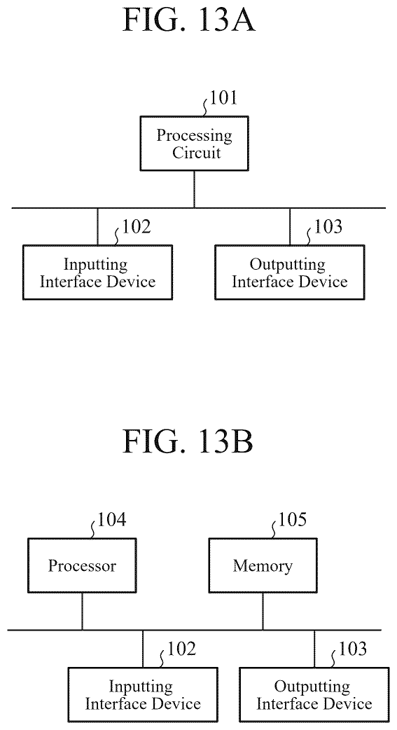

FIGS. 13A and 13B are diagrams each showing an example hardware configuration of the label creation device 1 according to the first embodiment.

In the first embodiment, the functions of the training data acquiring unit 11, the external factor region dividing unit 12, the external factor label data creating unit 13, and the control unit (not illustrated) are implemented by a processing circuit 101. That is, the label creation device 1 includes the processing circuit 101 for performing control to provide data that assists in construction of a diagnostic model that prevents a decrease in accuracy of diagnosis on degradation of an apparatus due to the operating environment.

The processing circuit 101 may be dedicated hardware as shown in FIG. 13A, or may be a processor 104 that executes a program stored in a memory as shown in FIG. 13B.

In a case where the processing circuit 101 is dedicated hardware, the processing circuit 101 may be a single circuit, a composite circuit, a programmed processor, a parallel-programmed processor, an application specific integrated circuit (ASIC), a field-programmable gate array (FPGA), or a combination thereof.

In a case where the processing circuit is the processor 104, the functions of the training data acquiring unit 11, the external factor region dividing unit 12, the external factor label data creating unit 13, and the control unit (not illustrated) are implemented by software, firmware, or a combination of software and firmware. Software or firmware is written as a program, and is stored in a memory 105. The processor 104 reads and executes the program stored in the memory 105, to execute the functions of the training data acquiring unit 11, the external factor region dividing unit 12, the external factor label data creating unit 13, and the control unit (not illustrated). That is, the label creation device 1 includes the memory 105 for storing the program for eventually carrying out steps ST1 to ST4 in FIG. 8 described above, when the program is executed by the processor 104. It can also be said that the program stored in the memory 105 causes a computer to implement the processing procedures or the method to be implemented by the training data acquiring unit 11, the external factor region dividing unit 12, the external factor label data creating unit 13, and the control unit (not illustrated). Here, the memory 105 is a nonvolatile or volatile semiconductor memory, such as a RAM, a read only memory (ROM), a flash memory, an erasable programmable read only memory (EPROM), or an electrically erasable programmable read-only memory (EEPROM) (registered trademark, hereinafter not mentioned), a magnetic disk, a flexible disk, an optical disk, a compact disk, a mini disk, a digital versatile disc (DVD), or the like, for example.

Note that the functions of the training data acquiring unit 11, the external factor region dividing unit 12, the external factor label data creating unit 13, and the control unit (not illustrated) may be partially implemented by dedicated hardware, and be partially implemented by software or firmware. For example, the functions of the training data acquiring unit 11 can be implemented by the processing circuit 101 as dedicated hardware, and the functions of the external factor region dividing unit 12, the external factor label data creating unit 13, and the control unit (not illustrated) can be implemented by the processor 104 reading and executing the program stored in the memory 105.

Also, the label creation device 1 includes an inputting interface device 102 and an outputting interface device 103 that perform wired communication or wireless communication with a device such as the diagnostic model creation device 2 or the storage device 4.

Examples of the hardware configuration of the diagnostic model creation device 2 according to the first embodiment are also as illustrated in FIGS. 13A and 13B.

In the first embodiment, the functions of the diagnostic model creating unit 21 and the control unit (not illustrated) are implemented by the processing circuit 101. That is, the diagnostic model creation device 2 includes the processing circuit 101 for performing control to create a diagnostic model on the basis of external factor label data created by the label creation device 1.

The processing circuit 101 may be dedicated hardware as shown in FIG. 13A, or may be a processor 104 that executes a program stored in a memory as shown in FIG. 13B.

In a case where the processing circuit 101 is dedicated hardware, the processing circuit 101 may be a single circuit, a composite circuit, a programmed processor, a parallel-programmed processor, an application specific integrated circuit (ASIC), a field-programmable gate array (FPGA), or a combination thereof.

In a case where the processing circuit is the processor 104, the functions of the diagnostic model creating unit 21 and the control unit (not illustrated) are implemented by software, firmware, or a combination of software and firmware. Software or firmware is written as a program, and is stored in the memory 105. The processor 104 reads and executes the program stored in the memory 105, to execute the functions of the diagnostic model creating unit 21 and the control unit (not illustrated). That is, the diagnostic model creation device 2 includes the memory 105 for storing the program for eventually carrying out step ST4 in FIG. 8 described above, when the program is executed by the processor 104. It can also be said that the program stored in the memory 105 causes a computer to implement the processing procedures or the method to be implemented by the diagnostic model creating unit 21 and the control unit (not illustrated).

Note that the functions of the diagnostic model creating unit 21 and the control unit (not illustrated) may be partially implemented by dedicated hardware, and be partially implemented by software or firmware.

Also, the diagnostic model creation device 2 includes the inputting interface device 102 and the outputting interface device 103 that perform wired communication or wireless communication with a device such as the label creation device 1 or the storage device 4.

Examples of the hardware configuration of the degradation diagnostic device 3 according to the first embodiment are also as illustrated in FIGS. 13A and 13B.

In the first embodiment, the functions of the diagnostic data acquiring unit 31, the model determining unit 32, the model acquiring unit 33, the feature extracting unit 34, the diagnosis unit 35, the diagnosis result outputting unit 36, and the control unit (not illustrated) are implemented by the processing circuit 101. That is, in the degradation diagnostic device 3, the diagnostic model creation device 2 includes the processing circuit 101 for performing control to perform degradation diagnosis on the target apparatus, using a diagnostic model created on the basis of the external factor label data created by the label creation device 1.

The processing circuit 101 may be dedicated hardware as shown in FIG. 13A, or may be a processor 104 that executes a program stored in a memory as shown in FIG. 13B.

In a case where the processing circuit 101 is dedicated hardware, the processing circuit 101 may be a single circuit, a composite circuit, a programmed processor, a parallel-programmed processor, an application specific integrated circuit (ASIC), a field-programmable gate array (FPGA), or a combination thereof.

In a case where the processing circuit is the processor 104, the functions of the diagnostic data acquiring unit 31, the model determining unit 32, the model acquiring unit 33, the feature extracting unit 34, the diagnosis unit 35, the diagnosis result outputting unit 36 and the control unit (not illustrated) are implemented by software, firmware, or a combination of software and firmware. Software or firmware is written as a program, and is stored in a memory 105. The processor 104 reads and executes the program stored in the memory 105, to execute the functions of the diagnostic data acquiring unit 31, the model determining unit 32, the model acquiring unit 33, the feature extracting unit 34, the diagnosis unit 35, the diagnosis result outputting unit 36, and the control unit (not illustrated). That is, the degradation diagnostic device 3 includes the memory 105 for storing the program for eventually carrying out steps ST21 to ST26 in FIG. 11 described above, when the program is executed by the processor 104. It can also be said that the program stored in the memory 105 causes a computer to implement the processing procedures or the method to be implemented by the diagnostic data acquiring unit 31, the model determining unit 32, the model acquiring unit 33, the feature extracting unit 34, the diagnosis unit 35, the diagnosis result outputting unit 36, and the control unit (not illustrated).

Note that the functions of the diagnostic data acquiring unit 31, the model determining unit 32, the model acquiring unit 33, the feature extracting unit 34, the diagnosis unit 35, the diagnosis result outputting unit 36, and the control unit (not illustrated) may be partially implemented by dedicated hardware, and be partially implemented by software or firmware.

Also, the degradation diagnostic device 3 includes the inputting interface device 102 and the outputting interface device 103 that perform wired communication or wireless communication with a device such as the sensor 5 or the storage device 4.

As described above, the label creation device 1 according to the first embodiment includes: the training data acquiring unit 11 that acquires training data in which a feature that can be used to create a diagnostic model to be used in degradation diagnosis on the target apparatus as the degradation diagnosis subject is associated with external factor data related to the operating environment; the external factor region dividing unit 12 that classifies, on the basis of the training data acquired by the training data acquiring unit 11, a range of values of the external factor data in the axial direction of the external factor data into a constant band that is a range of values of the external factor data in which the relationship with the corresponding feature is estimated to be constant, and a transition band that is a range of values of the external factor data in which the relationship with the corresponding feature is estimated to change frequently; and the external factor label data creating unit 13 that creates external factor label data in which ranges of values of the external factor data are associated with external factor labels, by assigning an external factor label indicating that the relationship between the external factor data in the range and the corresponding feature is constant to the range of values of the external factor data classified as the constant band, and assigning an external factor label indicating that the relationship between the external factor data in the range and the corresponding feature changes frequently to the range of values of the external factor data classified as the transition band, with respect to the axis of the external factor data.

Accordingly, the label creation device 1 can provide data that assists in construction of a diagnostic model that prevents a decrease in accuracy of diagnosis on degradation of the target apparatus due to the operating environment. As a result, the label creation device 1 can contribute to construction of a diagnostic model that prevents a decrease in accuracy of diagnosis on degradation of the target apparatus due to the operating environment, and can contribute to achieving accurate degradation diagnosis with the diagnostic model. Also, the label creation device 1 can contribute to shortening of the time for designing a diagnostic model.

Further, in creating the external factor label data, the label creation device 1 focuses on the relationship between the feature based on the sensor data in a normal state of the target apparatus and the external factor, or, in other words, the training data to be used by the label creation device 1 creating the external factor label data is only required to be data corresponding to at least the relationship between the feature based on the sensor data in a normal state of the target apparatus and the external factor. Accordingly, it is possible to reduce the work required for creating training data.

Further, by providing the external factor data, the label creation device 1 can cause the operator or the like to clearly grasp which external factor causes the diagnostic model to switch at which timing, for example.

Also, the diagnostic model creation device 2 according to the first embodiment includes: the label creation device 1 that includes: the training data acquiring unit 11 that acquires training data in which a feature that can be used to create a diagnostic model to be used in degradation diagnosis on the target apparatus as the degradation diagnosis subject is associated with external factor data related to the operating environment; the external factor region dividing unit 12 that classifies, on the basis of the training data acquired by the training data acquiring unit 11, a range of values of the external factor data in the axial direction of the external factor data into a constant band that is a range of values of the external factor data in which the relationship with the corresponding feature is estimated to be constant, and a transition band that is a range of values of the external factor data in which the relationship with the corresponding feature is estimated to change frequently; and the external factor label data creating unit 13 that creates external factor label data in which ranges of values of the external factor data are associated with external factor labels, by assigning an external factor label indicating that the relationship between the external factor data in the range and the corresponding feature is constant to the range of values of the external factor data classified as the constant band, and assigning an external factor label indicating that the relationship between the external factor data in the range and the corresponding feature changes frequently to the range of values of the external factor data classified as the transition band, with respect to the axis of the external factor data; and the diagnostic model creating unit 21 that acquires, on the basis of the external factor label data created by the external factor label data creating unit 13 in the label creation device 1, the training data corresponding to the range of values of the external factor data associated with the external factor label indicating that the range is a range in which the relationship between the external factor data in the range and the corresponding feature is constant, and creates a diagnostic model using the acquired training data.

By creating a diagnostic model on the basis of the external factor label data created by the label creation device 1, the diagnostic model creation device 2 can construct a diagnostic model that prevents a decrease in accuracy of diagnosis on degradation of an apparatus due to the operating environment.

Further, the degradation diagnostic device 3 according to the first embodiment performs degradation diagnosis on the target apparatus, using a diagnostic model created by the diagnostic model creation device 2 that includes: the label creation device 1 that includes: the training data acquiring unit 11 that acquires training data in which a feature that can be used to create a diagnostic model to be used in degradation diagnosis on the target apparatus as the degradation diagnosis subject is associated with external factor data related to the operating environment; the external factor region dividing unit 12 that classifies, on the basis of the training data acquired by the training data acquiring unit 11, a range of values of the external factor data in the axial direction of the external factor data into a constant band that is a range of values of the external factor data in which the relationship with the corresponding feature is estimated to be constant, and a transition band that is a range of values of the external factor data in which the relationship with the corresponding feature is estimated to change frequently; and the external factor label data creating unit 13 that creates external factor label data in which ranges of values of the external factor data are associated with external factor labels, by assigning an external factor label indicating that the relationship between the external factor data in the range and the corresponding feature is constant to the range of values of the external factor data classified as the constant band, and assigning an external factor label indicating that the relationship between the external factor data in the range and the corresponding feature changes frequently to the range of values of the external factor data classified as the transition band, with respect to the axis of the external factor data; and the diagnostic model creating unit 21 that acquires, on the basis of the external factor label data created by the external factor label data creating unit 13 in the label creation device 1, the training data corresponding to the range of values of the external factor data associated with the external factor label indicating that the range is a range in which the relationship between the external factor data in the range and the corresponding feature is constant, and creates the diagnostic model using the acquired training data.

The degradation diagnostic device 3 according to the first embodiment includes: the diagnostic data acquiring unit 31 that acquires diagnostic data including sensor data related to an operating state of a target apparatus and external factor data related to an operating environment of the target apparatus; the model determining unit 32 that determines a diagnostic model to be used in degradation diagnosis, on the basis of the external factor data acquired by the diagnostic data acquiring unit 31 and data indicating a range of values of the external factor data associated with the diagnostic model; the model acquiring unit 33 that acquires the diagnostic model determined to be used in degradation diagnosis by the model determining unit 32; the feature extracting unit 34 that extracts a feature from the sensor data acquired by the diagnostic data acquiring unit 31; the diagnosis unit 35 that performs degradation diagnosis on the target apparatus on the basis of the feature extracted by the feature extracting unit 34, using the diagnostic model acquired by the model acquiring unit 33 for the external factor data corresponding to the feature; and the diagnosis result outputting unit 36 that outputs a result of the degradation diagnosis performed on the target apparatus by the diagnosis unit 35.

The degradation diagnostic device 3 performs degradation diagnosis on the target apparatus using the diagnostic model created by taking into account the possibility that an accurate diagnosis result cannot be obtained before and after switching due to the operating environment, and thus, can perform accurate degradation diagnosis.

Further, the information processing system 6 according to the first embodiment includes the label creation device 1, the diagnostic model creation device 2, and the degradation diagnostic device 3, which have been described above.

Thus, the information processing system 6 can provide data that assists in construction of a diagnostic model that prevents a decrease in accuracy of diagnosis on degradation of the target apparatus due to the operating environment. Also, the information processing system 6 can construct a diagnostic model that prevents a decrease in accuracy of diagnosis on degradation of the target apparatus due to the operating environment, and can achieve accurate degradation diagnosis with the diagnostic model.

Note that, in the present disclosure, it is possible to modify any of the components of the embodiment, or omit any of the components in the embodiment.

### INDUSTRIAL APPLICABILITY

A label creation device according to the present disclosure can provide data that assists in construction of a diagnostic model that prevents a decrease in accuracy of diagnosis on degradation of an apparatus due to the operating environment.

### REFERENCE SIGNS LIST

1: label creation device, 11: training data acquiring unit, 12: external factor region dividing unit, 121: inflection point extracting unit, 122: provisional region setting unit, 123: relational model creating unit, 124: relational model evaluating unit, 125: region determining unit, 13: external factor label data creating unit, 2: diagnostic model creation device, 21: diagnostic model creating unit, 211: reliability determining unit, 3: degradation diagnostic device, 31: diagnostic data acquiring unit, 32: model determining unit, 33: model acquiring unit, 34: feature extracting unit, 35: diagnosis unit, 36: diagnosis result outputting unit, 4: storage device, 41: training data storing unit, 42: external factor label data storing unit, 43: diagnostic model storing unit, 5: sensor, 6: information processing system, 101: processing circuit, 102: inputting interface device, 103: outputting interface device, 104: processor, 105: memory

1. A label creation device comprising:
processing circuitry configured to
acquire training data in which a feature to be used to create a diagnostic model used in degradation diagnosis on a target apparatus as a degradation diagnosis subject is associated with external factor data related to an operating environment;
classify, on a basis of the acquired training data, a range of value of the external factor data in an axial direction of the external factor data into a constant band that is a range of value of the external factor data in which a relationship with the corresponding feature is estimated to be constant, and a transition band that is a range of value of the external factor data in which the relationship with the corresponding feature is estimated to change frequently; and
assign an external factor label indicating that a relationship between the external factor data in the range and the corresponding feature is constant, to the range of value of the external factor data classified as the constant band, with respect to an axis of the external factor data, assign an external factor label indicating that the relationship between the external factor data in the range and the corresponding feature changes frequently, to the range of value of the external factor data classified as the transition band, with respect to the axis of the external factor data, and create external factor label data in which ranges of value of the external factor data are associated with external factor labels.

2. The label creation device according to claim 1, wherein
the processing circuitry is further configured to
extract a plurality of inflection points at which a relationship between the feature and the external factor data changes in the axial direction of the external factor data;
select a first inflection point and a second inflection point adjacent to each other among the plurality of inflection points extracted and set a provisional region as a candidate for the constant band in an inflection point range, the inflection point range being a range of value of the external factor data between the selected first inflection point and the selected second inflection point;
create a relational model indicating a relationship between the feature and the external factor data, on a basis of the value of the external factor data and the value of the feature corresponding to the value of the external factor data in the provisional region;
evaluate accuracy of the relational model, using the value of the external factor data included in the provisional region and the value of the feature corresponding to the value of the external factor data; and
determine, when the accuracy of the relational model is evaluated to be low, that the provisional region in which the accuracy of the relational model is evaluated to be high is set as the constant band and that a range of value of the external factor data other than the determined constant band is set as the transition band, and
re-set, when the accuracy of the relational model is evaluated to be low, the provisional region by narrowing the range of the provisional region and re-create the relational model and re-evaluate the accuracy of the relational model.

3. The label creation device according to claim 1, wherein
the external factor data includes the external factor data related to a plurality of the operating environments,
the feature includes a plurality of the features used to create the diagnostic model used in degradation diagnosis on the target apparatus as the degradation diagnosis subject,
classify the range of value of the external factor data into the constant band and the transition band, for each set of the external factor data and the feature, and
create the external factor label data for each set of the external factor data and the feature.

4. A diagnostic model creation device comprising:
the label creation device according to claim 1; and
second processing circuitry configured to acquire training data corresponding to the range of value of the external factor data associated with the external factor label indicating a range in which the relationship between the external factor data in the region and the corresponding feature is constant, on a basis of the external factor label data having been created and create the diagnostic model using the acquired training data.

5. The diagnostic model creation device according to claim 4, wherein
the second processing circuitry is configured to associates the diagnostic model with data indicating a range of value of the external factor data corresponding to the training data used in creating the diagnostic model.

6. The diagnostic model creation device according to claim 4, wherein
the second processing circuitry is configured to
determine reliability of the diagnostic model, on a basis of the number of pieces of the training data used in creating the diagnostic model.

7. A degradation diagnostic device that performs the degradation diagnosis on the target apparatus, using the diagnostic model created by the diagnostic model creation device according to claim 4, wherein
the diagnostic model is associated with data indicating a range of value of the external factor data corresponding to the training data used in creating the diagnostic model, and
the second processing circuitry is configured to
acquire diagnostic data including sensor data related to an operating state of the target apparatus and the external factor data related to the operating environment of the target apparatus;
determine the diagnostic model to be used in the degradation diagnosis, on a basis of the acquired external factor data and data indicating a range of value of the external factor data associated with the diagnostic model;
acquire the diagnostic model determined to be used in the degradation diagnosis
extract a feature from the acquired sensor data;
perform the degradation diagnosis on the target apparatus on a basis of the extracted feature, using the acquired diagnostic model for the external factor data corresponding to the feature; and
output a result of the degradation diagnosis performed on the target apparatus.

8. The degradation diagnostic device according to claim 7, wherein
data indicating reliability determined on a basis of the number of pieces of the training data used in creating the diagnostic model is added to the diagnostic model, and
the second processing circuitry is configured to output the degradation diagnosis result and data indicating the reliability of the diagnostic model used in the degradation diagnosis.

9. An information processing system comprising:
the label creation device according to claim 1;
a diagnostic model creation device including second processing circuitry configured to acquire training data corresponding to the range of value of the external factor data associated with the external factor label indicating a range in which the relationship between the external factor data in the region and the corresponding feature is constant, on a basis of the external factor label data having been created and create the diagnostic model using the acquired training data; and
a degradation diagnostic device that performs the degradation diagnosis on the target apparatus, using the diagnostic model created by the diagnostic model creation device, wherein
the diagnostic model is associated with data indicating a range of value of the external factor data corresponding to the training data used in creating the diagnostic model,
the degradation diagnostic device including third processing circuitry is configured to:
acquire diagnostic data including sensor data related to an operating state of the target apparatus and the external factor data related to the operating environment of the target apparatus;
determine the diagnostic model to be used in the degradation diagnosis, on a basis of the acquired external factor data and data indicating a range of value of the external factor data associated with the diagnostic model;
acquire the diagnostic model determined to be used in the degradation diagnosis
extract a feature from the acquired sensor data;
perform the degradation diagnosis on the target apparatus on a basis of the extracted feature, using the acquired diagnostic model for the external factor data corresponding to the feature; and
output a result of the degradation diagnosis performed on the target apparatus.

10. A label creation method comprising:
acquiring training data in which a feature used in creating a diagnostic model to be used in degradation diagnosis on a target apparatus as a degradation diagnosis subject is associated with external factor data related to an operating environment;
classifying on a basis of the training data having been acquired, a range of value of the external factor data in an axial direction of the external factor data into a constant band that is a range of value of the external factor data in which a relationship with the corresponding feature is estimated to be constant, and a transition band that is a range of value of the external factor data in which the relationship with the corresponding feature is estimated to change frequently; and
creating external factor label data in which ranges of value of the external factor data are associated with external factor labels, by assigning an external factor label indicating that a relationship between the external factor data in the range and the corresponding feature is constant to the range of value of the external factor data classified as the constant band, and assigning an external factor label indicating that the relationship between the external factor data in the range and the corresponding feature changes frequently to the range of value of the external factor data classified as the transition band, with respect to an axis of the external factor data.
